(19) United States
(12) Patent Application Publication
(10) Pub. No.: US 2024/0381385 A1
(43) Pub. Date: Nov. 14, 2024

(54) RESOURCE DETERMINING METHOD, APPARATUS, DEVICE, STORAGE MEDIUM AND PROGRAM PRODUCT

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN); Shichang ZHANG, Dongguan (CN)

(21) Appl. No.: 18/776,640

(22) Filed: Jul. 18, 2024

Related U.S. Application Data
(63) Continuation of application No. PCT/CN2022/076194, filed on Feb. 14, 2022.

(51) Int. Cl. H04W 72/25; H04W 72/542

(52) U.S. Cl. CPC H04W 72/25; H04W 72/542

(57) ABSTRACT

A resource determining method includes: determining a transmission resource according to first sidelink control information and second sidelink control information, where the first sidelink control information and the second sidelink control information are two different pieces of sidelink control information.

### CROSS-REFERENCE TO RELATED APPLICATION

This application is a Continuation Application of PCT/CN2022/076194 filed Feb. 14, 2022, which is incorporated herein by reference in its entirety.

### TECHNICAL FIELD

Embodiments of the present application relate to the field of communications technology, and in particular, to a resource determining method, an apparatus, a device, a storage medium, and a program product.

### BACKGROUND

In sidelink (SL) communications, a terminal device may select a transmission resource in a resource pool by way of monitoring. At present, further study would be needed on a resource determining method for new radio (NR) systems.

### SUMMARY

According to an aspect of embodiments of the present application, a resource determining method is provided. The method is performed by a terminal device, and includes:
determining a transmission resource according to first sidelink control information and second sidelink control information, where the first sidelink control information and the second sidelink control information are two different pieces of sidelink control information.

According to an aspect of embodiments of the present application, a resource exclusion method is provided. The method is performed by a terminal device, and includes:
performing resource exclusion according to first sidelink control information and second sidelink control information, where the first sidelink control information and the second sidelink control information are two different pieces of sidelink control information.

According to an aspect of embodiments of the present application, a resource exclusion method is provided. The method is performed by a terminal device, and includes:
performing resource exclusion according to first sidelink control information and a target resource set, where the target resource set is determined according to second sidelink control information, and the first sidelink control information and the second sidelink control information are two different pieces of sidelink control information.

According to an aspect of embodiments of the present application, a resource determining apparatus is provided, which includes:
a processing module, configured to determine a transmission resource according to first sidelink control information and second sidelink control information, where the first sidelink control information and the second sidelink control information are two different pieces of sidelink control information.

According to an aspect of embodiments of the present application, a resource exclusion apparatus is provided, which includes:
an exclusion module, configured to perform resource exclusion according to first sidelink control information and second sidelink control information, where the first sidelink control information and the second sidelink control information are two different pieces of sidelink control information.

According to an aspect of embodiments of the present application, a resource exclusion apparatus is provided, which includes:
an exclusion module, configured to perform resource exclusion according to first sidelink control information and a target resource set, where the target resource set is determined according to second sidelink control information, and the first sidelink control information and the second sidelink control information are two different pieces of sidelink control information.

According to an aspect of embodiments of the present application, a terminal device is provided, which includes a processor and a memory. The memory has a computer program stored therein, and the processor executes the computer program to implement the foregoing resource determining method or resource exclusion method.

According to an aspect of embodiments of the present application, a non-transitory computer-readable storage medium is provided, which has a computer program stored thereon. The computer program is configured to be executed by a processor to cause the foregoing resource determining method or resource exclusion method to be implemented.

According to an aspect of embodiments of the present application, a chip is provided, which includes a programmable logic circuit and/or program instructions. When the chip is operating, the chip is configured to implement the foregoing resource determining method or resource exclusion method.

According to an aspect of embodiments of the present application, a computer program product or computer program is provided. The computer program product or computer program includes computer instructions stored in a non-transitory computer-readable storage medium. The processor reads and executes the computer instructions from the non-transitory computer-readable storage medium to implement the foregoing resource determining method or resource exclusion method.

### BRIEF DESCRIPTION OF THE DRAWINGS

FIG. 1 is a schematic diagram of a network architecture provided by an embodiment of the present application;

FIGS. 2A and 2B are schematic diagrams illustrating two transmission modes provided by an embodiment of the present application;

FIG. 3 is a schematic diagram illustrating an NR V2X physical layer structure provided by an embodiment of the present application;

FIG. 4 is a schematic diagram illustrating time-frequency resource location reservation provided by an embodiment of the present application;

FIG. 5 is a schematic diagram illustrating resource sensing and resource selection provided by an embodiment of the present application;

FIG. 6 is a schematic diagram illustrating an LTE V2X physical layer structure provided by an embodiment of the present application;

FIG. 7 is a flowchart of a resource determining method provided by an embodiment of the present application;

FIG. 8 is a flowchart of a resource exclusion method provided by an embodiment of the present application;

FIG. 9 is a flowchart of a resource exclusion method provided by another embodiment of the present application;

FIG. 10 is a flowchart of a resource exclusion method provided by another embodiment of the present application;

FIG. 11 is a flowchart of a resource exclusion method provided by another embodiment of the present application;

FIG. 12 is a block diagram of a resource determining apparatus provided by an embodiment of the present application; and

FIG. 13 is a schematic structural diagram of a terminal device provided by an embodiment of the present application.

### DETAILED DESCRIPTION

In order to make the objectives, technical solutions, and advantages of the present application clear, implementations of the present application will be further described in detail with reference to the drawings.

Network architectures and service scenarios described in the embodiments of the present application are intended to describe technical solutions of the embodiments of the present application more clearly, but do not constitute any limitation on technical solutions provided in the embodiments of the present application. Those of ordinary skill in the art may know that as the network architecture evolves and new service scenarios emerge, the technical solutions provided in the embodiments of the present application are also applicable to similar technical problems.

A resource determining method is provided in the embodiments of the present application. The method may be performed by a terminal device and includes:
determining a transmission resource according to first sidelink control information and second sidelink control information, where the first sidelink control information and the second sidelink control information are two different pieces of sidelink control information.

In some embodiments, determining the transmission resource according to the first sidelink control information and the second sidelink control information includes:
performing resource exclusion according to the first sidelink control information and the second sidelink control information; and
determining the transmission resource from non-excluded resources.

In some embodiments, performing resource exclusion according to the first sidelink control information and the second sidelink control information includes:
determining a resource selection window and resource sensing window(s);
determining available resources in the resource selection window as an initialized resource set; and
performing a resource exclusion step to exclude resource(s) from the resource set;
   where the resource exclusion step includes a first exclusion step and a second exclusion step, the first exclusion step is used for resource exclusion based on the first sidelink control information detected in the resource sensing window(s), and the second exclusion step is used for resource exclusion based on the second sidelink control information detected in the resource sensing window(s).

In some embodiments, the first exclusion step is performed prior to the second exclusion step, or the first exclusion step is performed after the second exclusion step.

In some embodiments, the resource exclusion step further includes a third exclusion step, and the third exclusion step is used for resource exclusion based on unmonitored time unit(s) in the resource sensing window(s).

In some embodiments, the third exclusion step includes:
determining Q3 time units corresponding to the unmonitored time unit(s) according to resource reservation period(s) in a first resource reservation period set and/or a second resource reservation period set and the unmonitored time unit(s), where Q3 is a positive integer; and
in response that the Q3 time units overlap with a target resource in the resource set or a periodic resource corresponding to the target resource, excluding the target resource from the resource set.

In some embodiments, the first resource reservation period set includes one or more types of resource reservation periods allowed in a first communication system; or the first resource reservation period set includes one or more types of resource reservation periods allowed in the first communication system and one or more types of resource reservation periods allowed in a second communication system. The first communication system is a communication system corresponding to the first sidelink control information, and the second communication system is a communication system corresponding to the second sidelink control information.

In some embodiments, the second resource reservation period set includes one or more types of resource reservation periods allowed in a second communication system, and the second communication system is a communication system corresponding to the second sidelink control information.

In some embodiments, the first exclusion step includes:
determining, according to a first time unit in which the first sidelink control information is detected and a resource reservation period indicated by the first sidelink control information, Q1 time units corresponding to the first time unit; assuming that pieces of first sidelink control information with same content are to be received in the Q1 time units, where Q1 is a positive integer; and in response that resources indicated by first sidelink control information detected or assumed to be received overlap with a target resource in the resource set or a periodic resource corresponding to the target resource and a first reference signal received power (RSRP) threshold condition is met, excluding the target resource from the resource set; or
determining whether resources indicated by detected first sidelink control information overlap with the target resource in the resource set or the periodic resource corresponding to the target resource; and in response that the resources indicated by the detected first sidelink control information overlap with the target resource in the resource set or the periodic resource corresponding to the target resource and the first RSRP threshold condition is met, excluding the target resource from the resource set.

In some embodiments, the second exclusion step includes:
determining, according to a second time unit in which the second sidelink control information is detected and a resource reservation period indicated by the second sidelink control information, Q2 time units corresponding to the second time unit; assuming that pieces of second sidelink control information with same content are to be received in the Q2 time units, where Q2 is a positive integer; and in response that resources indicated by second sidelink control information detected or assumed to be received overlap with a target resource in the resource set or a periodic resource corresponding to the target resource and a second RSRP threshold condition is met, excluding the target resource from the resource set.

In some embodiments, a same RSRP threshold table is configured for the first exclusion step and the second exclusion step; or different RSRP threshold tables are configured for the first exclusion step and the second exclusion step.

In some embodiments, the resource sensing window(s) include a first resource sensing window and a second resource sensing window. The terminal device detects the first sidelink control information in the first resource sensing window and the second sidelink control information in the second resource sensing window. The first resource sensing window and the second resource sensing window are two different resource sensing windows.

In some embodiments, the resource sensing window(s) include a first resource sensing window, and the terminal device detects the first sidelink control information and the second sidelink control information in the first resource sensing window; or the resource sensing window(s) include a second resource sensing window, and the terminal device detects the first sidelink control information and the second sidelink control information in the second resource sensing window. The first resource sensing window and the second resource sensing window are two different resource sensing windows.

In some embodiments, determining the transmission resource according to the first sidelink control information and the second sidelink control information includes:
performing resource exclusion according to the first sidelink control information and a target resource set, where the target resource set is determined according to the second sidelink control information; and
determining the transmission resource from non-excluded resources.

In some embodiments, performing resource exclusion according to the first sidelink control information and the target resource set includes:
determining a first resource selection window and a first resource sensing window;
determining available resources in the first resource selection window as an initialized first resource set; and
performing a first resource exclusion step to exclude resource(s) from the first resource set, where the first resource exclusion step includes a fourth exclusion step and a fifth exclusion step, the fourth exclusion step is used for resource exclusion based on the first sidelink control information detected in the first resource sensing window, and the fifth exclusion step is used for resource exclusion based on the target resource set.

Optionally, the method further includes:
after performing the fifth exclusion step, in response that a quantity of remaining resources in the first resource set is less than or equal to a threshold, initializing the first resource set to the first resource set obtained before performing the fifth exclusion step.

In some embodiments, the fourth exclusion step is performed prior to the fifth exclusion step, or the fourth exclusion step is performed after the fifth exclusion step.

In some embodiments, the first resource exclusion step further includes a sixth exclusion step, and the sixth exclusion step is used for resource exclusion based on unmonitored time unit(s) in the first resource sensing window.

In some embodiments, the sixth exclusion step includes:
determining Q6 time units corresponding to the unmonitored time unit(s) in the first resource sensing window according to resource reservation period(s) in a first resource reservation period set and the unmonitored time unit(s) in the first resource sensing window, where Q6 is a positive integer; and
in response that the Q6 time units overlap with a first resource in the first resource set or a periodic resource corresponding to the first resource, excluding the first resource from the first resource set.

In some embodiments, the first resource reservation period set includes one or more types of resource reservation periods allowed in a first communication system, and the first communication system is a communication system corresponding to the first sidelink control information.

In some embodiments, the fourth exclusion step includes:
determining, according to a first time unit in which the first sidelink control information is detected and a resource reservation period indicated by the first sidelink control information, Q4 time units corresponding to the first time unit; assuming that pieces of first sidelink control information with same content are to be received in the Q4 time units, where Q4 is a positive integer; and in response that resources indicated by first sidelink control information detected or assumed to be received overlap with a first resource in the first resource set or a periodic resource corresponding to the first resource and a first reference signal received power (RSRP) threshold condition is met, excluding the first resource from the first resource set; or
determining whether resources indicated by detected first sidelink control information overlap with the first resource in the first resource set or the periodic resource corresponding to the first resource; and in response that the resources indicated by the detected first sidelink control information overlap with the first resource in the first resource set or the periodic resource corresponding to the first resource and the first RSRP threshold condition is met, excluding the first resource from the first resource set.

In some embodiments, the target resource set includes resource(s) excluded according to the second sidelink control information, and the fifth exclusion step includes:
in response that a first resource in the first resource set overlaps with a resource in the target resource set, excluding the first resource from the first resource set.

In some embodiments, the target resource set includes remaining resource(s) after exclusion based on the second sidelink control information, and the fifth exclusion step includes:
in response that a first resource in the first resource set does not belong to the target resource set, excluding the first resource from the first resource set.

In some embodiments, the method further includes:
determining a second resource selection window and a second resource sensing window;
determining available resources in the second resource selection window as an initialized second resource set;
performing a second resource exclusion step to exclude resource(s) from the second resource set, where the second resource exclusion step includes a seventh exclusion step, and the seventh exclusion step is used for resource exclusion based on the second sidelink control information detected in the second resource sensing window; and
determining the target resource set according to excluded or remaining resource(s) in the second resource exclusion step.

In some embodiments, the second resource selection window is same as the first resource selection window, or the second resource selection window is different from the first resource selection window.

In some embodiments, the second resource sensing window is same as the first resource sensing window, or the second resource sensing window is different from the first resource sensing window.

In some embodiments, determining the target resource set according to the excluded or remaining resource(s) in the second resource exclusion step includes:
determining a second resource set obtained after the second resource exclusion step as the target resource set; or
determining a first quantity of resources with a lowest signal strength indicator (RSSI) in the second resource set obtained after the second resource exclusion step as the target resource set; or
determining resource(s) excluded in the second resource exclusion step as the target resource set; or
determining a difference set between the initialized second resource set and a third resource set as the target resource set, where the third resource set includes the first quantity of resources with a lowest RSSI in the second resource set obtained after the second resource exclusion step.

In some embodiments, the second resource exclusion step further includes an eighth exclusion step, and the eighth exclusion step is used for resource exclusion based on unmonitored time unit(s) in the second resource sensing window.

In some embodiments, the eighth exclusion step includes:
determining Q8 time units corresponding to the unmonitored time unit(s) in the second resource sensing window according to resource reservation period(s) in a second resource reservation period set and the unmonitored time unit(s) in the second resource sensing window, where Q8 is a positive integer; and
in response that the Q8 time units overlap with a second resource in the second resource set or a periodic resource corresponding to the second resource, excluding the second resource from the second resource set.

In some embodiments, the second resource reservation period set includes one or more types of resource reservation periods allowed in a second communication system, and the second communication system is a communication system corresponding to the second sidelink control information.

In some embodiments, the seventh exclusion step includes:
determining, according to a second time unit in which the second sidelink control information is detected and a resource reservation period indicated by the second sidelink control information, Q7 time units corresponding to the second time unit; assuming that pieces of second sidelink control information with same content are to be received in the Q7 time units, where Q7 is a positive integer; and in response that resources indicated by second sidelink control information detected or assumed to be received overlap with a second resource in the second resource set or a periodic resource corresponding to the second resource and a second RSRP threshold condition is met, excluding the second resource from the second resource set.

In some embodiments, a same RSRP threshold table is configured for a fourth exclusion step and a seventh exclusion step; or different RSRP threshold tables are configured for the fourth exclusion step and the seventh exclusion step. The fourth exclusion step is used for resource exclusion based on the first sidelink control information detected in the first resource sensing window, and the seventh exclusion step is used for resource exclusion based on the second sidelink control information detected in the second resource sensing window.

In some embodiments, the first sidelink control information is sidelink control information in a new radio (NR) system, and the second sidelink control information is sidelink control information in a long term evolution (LTE) system.

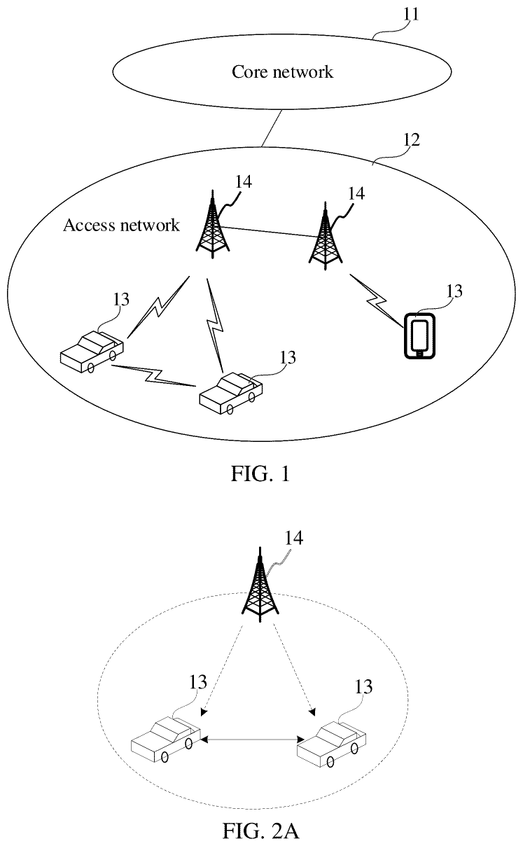

Reference is made to FIG. 1, which illustrates a schematic diagram of a network architecture, in accordance with an embodiment of the present application. The network architecture may include: a core network 11, an access network 12, and a terminal 13.

The core network 11 includes several core network devices. The core network device has functions of mainly providing user connection and user management, and completing bearing for service, and further functions as an interface to an external network provided by a bearer network. For example, a core network of a 5th generation (5G) new radio (NR) system may include an access and mobility management function (AMF) entity, a user plane function (UPF) entity, a session management function (SMF) entity.

The access network 12 includes several access network devices 14. The access network in the 5G NR system may be referred to as new generation radio access network (NG-RAN). The access network device 14 is a device that is deployed in the access network 12 and used to provide wireless communication functions for the terminal device 13. The access network device 14 may include various forms of macro base stations, micro base stations, relay stations, access points, etc. In systems employing different wireless access technologies, the devices with functions of the access network device may have different names. For example, in 5G NR systems, such devices are referred to as gNodeB or gNB. With the evolution of communication technologies, the name “access network device” may change. For convenience of description, in the embodiments of the present application, the apparatuses for providing wireless communication functions for the terminal device 13 as described above are collectively referred to as access network devices.

Typically, there are a plurality of terminal devices 13, and one or more terminal devices 13 may be distributed in a cell managed by each access network device 14. The terminal devices 13 may include various devices with the wireless communication functions, such as handheld devices, vehicle-mounted devices, wearable devices, computing devices, or other processing devices connected to wireless modems, or various forms of user equipments (UE), mobile stations (MS). For convenience of description, the above-mentioned devices are collectively referred to as terminal devices. The access network device 14 and the core network device communicate with each other based on a certain air technology, such as a NG interface in the 5G NR system. The access network device 14 and the terminal device 13 communicate with each other based on a certain air technology, such as a Uu interface.

In embodiments of the present application, two terminal devices 13 (e.g., a vehicle-mounted device and another device such as another vehicle-mounted device, a mobile phone, or a road side unit (RSU)) may communicate with each other through a direct-connection communication interface (e.g., a PC5 interface), and accordingly, a communication link established based on the direct-connection communication interface may be referred to as a direct link or sidelink (SL). SL transmission is a direct communication of communication data between terminal devices through sidelink. Different from reception or transmission of the communication data through the access network device in a traditional cellular system, the SL transmission has characteristics of short delay, low overhead, etc., and is suitable for communication between two terminal devices that are geographically close to each other (such as a vehicle-mounted device and other peripheral devices that are geographically close thereto). It should be noted that in FIG. 1, considering vehicle to vehicle communication in a vehicle to everything (V2X) scenario as an example, SL technology may be applied to scenarios where various terminal devices communicate directly with each other. In other words, the terminal devices in the present application refer to any devices that utilize SL technology for communication.

The “5G NR system” in the embodiments of the present application may also be referred to as a 5G system or an NR system, and those skilled in the art can understand the meaning. The technical solutions described in the embodiments of the present application may be applied to the 5G NR system, and may also be applied to a subsequent evolution system of the 5G NR system. In the embodiments of the present application, terms “terminal equipment” and “UE” usually express the same meaning, and the two may be used interchangeably, and those skilled in the art can understood the meaning.

Before introducing the technical solutions of the present application, some background technical knowledge involved in the embodiments of the present application will be introduced and explained. The following relevant technologies, as optional solutions, can be arbitrarily combined with the technical solutions of the embodiments of the present application, and these combined solutions all fall within the protection scope of the embodiments of the present application. The embodiments of the present application include at least part of the following contents.

### 1. Sidelink (SL) Transmission

Device to device communication is a sidelink transmission technology, which is different from the way that communication data is received or sent through base stations in traditional cellular systems. For example, V2X systems have a high spectrum efficiency and low transmission delay due to the adoption of device-to-device direct communication. Regarding the SL transmission, 3rd Generation Partnership Project (3GPP) defines two transmission modes: Mode A and Mode B.

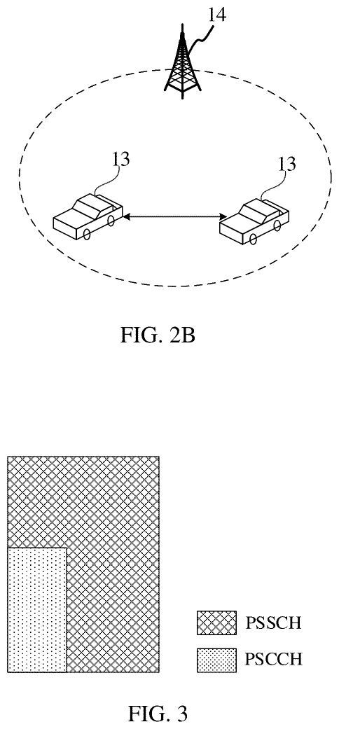

Mode A: as shown in FIG. 2A, transmission resources of a terminal device 13 are allocated by an access network device 14 (e.g. a base station), and the terminal device 13 transmits communication data through sidelink based on the transmission resources allocated by the access network device 14. The access network device 14 may allocate transmission resources for a single transmission to the terminal device 13, or may allocate transmission resources for semi-persistent transmission to the terminal device 13.

Mode B: as shown in FIG. 2B, the terminal device 13 autonomously selects transmission resources from a resource pool to transmit the communication data. Specifically, the terminal device 13 may select transmission resources from the resource pool by way of monitoring, or select transmission resources from the resource pool by way of random selecting.

The SL communication in an NR V2X system and a long term evaluation (LTE) V2X, as well as a method for a terminal device to autonomously select resource (i.e., the above Mode B) will be mainly described below.

### 2. NR V2X Physical Layer Structure

The physical layer structure of SL communication in the NR V2X system is shown in FIG. 3. A physical sidelink control channel (PSCCH) is used to carry first sidelink control information, and a physical sidelink shared channel (PSSCH) is used to carry data and third sidelink control information. The PSCCH and the PSSCH are transmitted in the same slot. The first sidelink control information and the third sidelink control information may be two pieces of sidelink control information having different uses. For example, the first sidelink control information is carried in the PSCCH, and mainly includes fields related to resource sensing so as to facilitate resource exclusion and resource selection after decoding by other terminal devices. In addition to data, the PSSCH carries the third sidelink control information, which mainly includes fields related to data demodulation so as to facilitate demodulation for the data in the PSSCH by other terminal devices.

For example, the first sidelink control information is 1st-stage-SCI, i.e., the first-stage sidelink control information (SCI).

For example, the third sidelink control information is 2nd-stage-SCI, i.e., the second-stage SCI.

### 3. Resource Reservation in NR V2X

In the NR V2X system, the terminal device in Mode B autonomously selects transmission resources to send data. Resource reservation is a prerequisite for resource selection.

The resource reservation refers to that the terminal device sends the first sidelink control information in the PSCCH to reserve resources to be used subsequently. In the NR V2X system, resource reservation within a transport block (TB) is supported, and resource reservation between TB s is also supported.

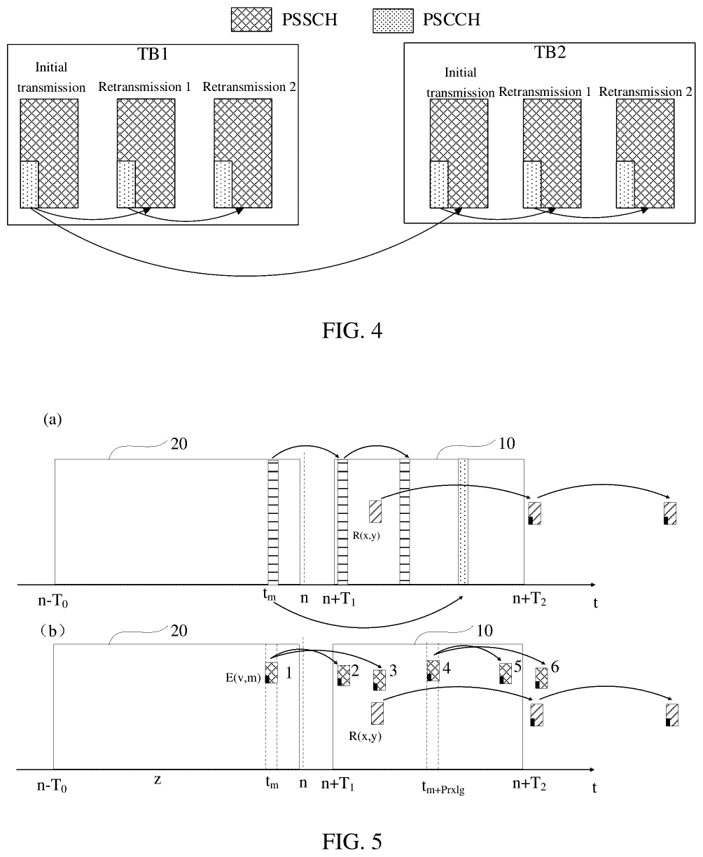

As shown in FIG. 4, the terminal device sends the first sidelink control information, in which a “Time resource assignment” field and a “Frequency resource assignment” field are used to indicate N time-frequency resources (including resources used for current transmission) in the current TB, where N≤Nmax, and in NR V2X, Nmax equals to 2 or 3. In addition, the indicated N time-frequency resources should be distributed in W slots. In NR V2X, W equals to 32. For example, in TB1 illustrated in FIG. 4, the terminal device sends the first sidelink control information in the PSCCH while sending data of initial transmission on the PSSCH, and the above mentioned two fields are used to indicate time-frequency resource locations for the initial transmission and retransmission 1 (that is, in this case, N=2); that is, time-frequency resources for the retransmission 1 are reserved. Moreover, the initial transmission and retransmission 1 are distributed within 32 slots in the time domain. Similarly, in TB1 illustrated in FIG. 4, the terminal device indicates time-frequency resource locations for retransmission 1 and retransmission 2 by using the first sidelink control information sent in the PSCCH of retransmission 1, and retransmission 1 and retransmission 2 are distributed within 32 slots in the time domain.

In the case where the terminal device sends the first sidelink control information, a “Resource reservation period” field is used for resource reservation between TBs. For example, in FIG. 4, in the case where the terminal devices sends the first sidelink control information for initial transmission of TB1, time-frequency resource locations for the initial transmission of TB1 and retransmission 1 of TB1 are indicated by using the “Time resource assignment” field and “Frequency resource assignment” field, and are denoted as {(t1, f1), (t2, f2)}, where t₁ and t₂ represent time domain locations of resources for the initial transmission and retransmission 1, and f₁ and f₂ represent corresponding frequency domain locations thereof. If the “Resource reservation period” field in the first sidelink control information has a value of 100 milliseconds, the SCI simultaneously indicates time-frequency resources {(t₁+100, f₁), (t₂+100, f₂)}, and these two resources are used for initial transmission and retransmission 1 of TB2. Similarly, in the first sidelink control information transmitted in retransmission 1 of TB1, the “Resource reservation period” field is also used to reserve time-frequency resources for retransmission 1 of TB2 and retransmission 2 of TB2. In NR V2X, the “Resource reservation period” field has the possible values of 0 milliseconds, 1 to 99 milliseconds, 100 milliseconds, 200 milliseconds, 300 milliseconds, 400 milliseconds, 500 milliseconds, 600 milliseconds, 700 milliseconds, 800 milliseconds, 900 milliseconds and 1000 milliseconds, which is more flexible than LTE V2X. However, in each resource pool, only e values of the possible values are configured, and the terminal device determines the possible values according to the used resource pool. The e values of the possible values in the resource pool configuration constitute a resource reservation period set M. Exemplarily, e is less than or equal to 16.

In addition, by way of configuring by network or pre-configuring, the reservation between TBs may be activated or deactivated on per resource pool basis. When it is intended to activate the reservation between TBs, the first sidelink control information includes the “Resource reservation period” field. When it is intended to deactivate the reservation between TBs is deactivated, the first sidelink control information does not include the “Resource reservation period” field. Generally, during activation of the reservation between TBs, before resource reselection is triggered, a value (i.e., a resource reservation period) of the “Resource reservation period” field used by the terminal device would not change. Every time the terminal device sends the first sidelink control information, the “Resource reservation period” field is configured to reserve resources for transmission of another TB in the next period, so as to achieve periodic semi-persistent transmission.

In the case where the terminal device operates in the Mode B, the terminal device may obtain the first sidelink control information sent by other terminal devices by sensing PSCCHs sent by other terminal devices, so as to determine resources reserved by the other terminal devices. The terminal device will exclude the resources reserved by the other terminal devices when performing resource selection, so as to avoid resource collision.

### 4. Resource Selection Method in NR V2X Sensing

In the NR V2X system, the terminal device needs to autonomously select resources in Mode B.

As shown in FIG. 5, the terminal device triggers resource selection or resource reselection in slot n, slot n being a slot where the higher layer triggers a physical layer to report a candidate resource set. A resource selection window 10 starts at n+T₁ and ends at n+T₂, where 0≤T1≤T_{proc,1}, when a subcarrier interval is 15 kHz, 30 kHz, 60 kHz, or 120 kHz, T_{proc,1} is 3 slots, 5 slots, 9 slots, or 17 slots, respectively, and T₂ₘᵢₙ≤T₂≤a residual delay budget of service. A set of values of T₂ₘᵢₙ is {1, 5, 10, 20}×2^{μ} slots, and cases where μ is equal to 0, 1, 2, or 3 correspond to the cases where the subcarrier interval is 15 kHz, 30 kHz, 60 kHz, or 120 kHz, respectively. The terminal device determines T₂ₘᵢₙ from the set of values according to a priority of data to be transmitted by the terminal device. For example, when the subcarrier interval is 15 kHz, the terminal device determines T₂ₘᵢₙ from a set {1, 5, 10, 20} according to the priority of the data to be transmitted by itself. When T₂ₘᵢₙ is greater than or equal to the residual delay budget of service, T₂ is equal to the residual delay budget of service. The residual delay budget is a difference between a moment corresponding to a data delay requirement and the current moment. For example, for a packet arriving at slot n, the delay requirement is 50 ms. Assuming that a slot has a duration of 1 ms, if the current moment is slot n, the residual delay budget is 50 ms; if the current time is slot n+20, the residual delay budget is 30 ms.

The terminal device performs resource sensing from n-T₀ to n-T_{proc,0} (excluding n-T_{proc,0}), and the value of T₀ is 100 ms or 1100 ms. When the subcarrier interval is 15 kHz, 30 kHz, 60 kHz, or 120 kHz, T_{proc,0} is 1 slot, 1 slot, 2 slots, or 4 slots, respectively. Optionally, the terminal device performs resource sensing in slots within a resource sensing window, which belong to a resource pool used by the terminal device. Optionally, the terminal device will detect the first sidelink control information sent by other terminal devices in each slot (except its own transmission slot). After the resource selection or the resource reselection is triggered at slot n, the terminal device uses the results of resource sensing between n-T₀ and n-T_{proc,0}.

In Step 1, the terminal device takes all available resources belonging to the resource pool used by the terminal device in resource selection window 10 as a resource set A. Any resource in the set A is denoted by R(x,y), where x and y respectively indicate frequency domain location and the time domain location of the resource. An initial number of resources in the set A is denoted by Mₜₒₜₐₗ. The terminal device excludes resources from the resource set A according to unmonitored slot(s) in a resource sensing window 20 (see Step 1-1) and/or a resource sensing result in the resource sensing window 20 (see Step 1-2). The terminal device determines whether the resource R(x,y) or a series of periodic resources corresponding to the resource R(x,y) overlaps with a slot determined according to the unmonitored slot(s) in Step 1-1 or resource determined according to the first sidelink control information detected in Step 1-2; if there is an overlap, the resource R(x,y) is excluded from the resource set A.

In Step 1-1, if the terminal device sends data at slot tₘ in the sensing window 20 without sensing, the terminal device will determine corresponding Q slots based on slot tₘ and each type of resource reservation period allowed in the resource pool used by the terminal device by taking the resource reservation period as an interval. If the Q slots overlap with the resource R(x,y) or the series of periodic resources corresponding to the resource R(x,y), the resource R(x,y) is excluded from the resource set A. Q=1 or Q=[Tscal/Prx] (representing rounding up), where Tscal is a value in milliseconds converted from T2, Prx is one type of the resource reservation periods allowed by the resource pool used by the terminal device. Optionally, the series of periodic resources corresponding to the resource R(x,y) are a series of periodic resources that are the same as frequency domain resource occupied by R(x,y) and mapped at certain time intervals, as shown in subfigures (a) and (b) of FIG. 5. The series of periodic resources corresponding to the resource R(x,y) includes the resource R(x,y).

For example, as illustrated in the subfigure (a) of FIG. 5, the terminal device does not perform sensing at slot tₘ, but performs resource exclusion sequentially according to each resource reservation period in the resource reservation period set M in the resource pool configuration used by the terminal device. For a certain resource reservation period 1, assuming that the value of Q is calculated to be 2, the corresponding Q slots are the next two slots mapped from the slot tₘ with the resource reservation period 1 as the interval, which are marked by horizontal shading in the subfigure (a) of FIG. 5. If the two slots marked by horizontal shading overlaps with the resource R(x,y) or the series of periodic resources corresponding to the resource R(x,y), the resource R(x,y) is excluded from the resource set A. For a certain resource reservation periods 2, assuming that the value of Q is calculated to be 1, the corresponding Q slot is one slot mapped from the slot tₘ with the resource reservation period 2 as the interval, which is marked by dot shading in the subfigure (a) of FIG. 5. If the slot marked by dot shading overlaps with the resource R(x,y) or the series of periodic resources corresponding to the resource R(x,y), the resource R(x,y) is excluded from the resource set A.

The terminal device will determine whether Q slot(s) corresponding to each reservation period overlap with the resource R(x,y) or the series of periodic resources corresponding to the resource R(x,y), and if there is an overlap, the resource R(x,y) is excluded from the resource set A.

Optionally, the terminal device may not perform the above Step 1-1 when the resource pool used by the terminal device deactivates the reservation between TBs.

Optionally, after Step 1-1 is executed, if the remaining resources in the resource set A are less than Mₜₒₜₐₗ×X, the resource set A is initialized to all the available resources belonging to the resource pool used by the terminal device in the resource selection window 10, and then Step 1-2 is executed.

In Step 1-2, if the terminal device detects the first sidelink control information transmitted in the PSCCH within slot tₘ in the resource sensing window 20, sidelink reference signal received power (SL-RSRP) of the PSCCH or SL-RSRP of the PSSCH scheduled by the PSCCH (i.e., the SL-RSRP of the PSSCH transmitted in the same slot as the PSCCH) is measured.

If the measured SL-RSRP is greater than a SL-RSRP threshold, and the first sidelink control information detected by the terminal device includes the “Resource reservation period” field, the terminal device determines the corresponding Q slots based on the slot tₘ and a resource reservation period carried in the detected first sidelink control information by taking the resource reservation period as an interval. Assuming that the terminal device receives pieces of first sidelink control information having the same content in the Q slots, the terminal device determines whether the resources indicated by “Time resource assignment” fields and “Frequency resource assignment” fields in the first sidelink control information received in slot tₘ and the Q pieces of first sidelink control information that are assumed to be received overlap with the resource R(x,y) or the series of periodic resources corresponding to the resource R(x,y), and excludes the corresponding resource R(x,y) from the set A if there is an overlap. Q=1 or Q=[Tscal/Prx] (representing rounding up), where Tscal is a value in milliseconds converted from T₂, and Prx is a resource reservation period carried in the detected first sidelink control information.

For example, as illustrated in subfigure (b) of FIG. 5, if the terminal device detects the first sidelink control information in the PSCCH at slot tₘ, the first sidelink control information includes the “Resource reservation period” field, and the resource reservation period indicated by the field is Prx. It is assumed that the value of Q is calculated to be 1, and the terminal device receives the first sidelink control information having the same content in the next slot (i.e., the slot where resource 4 is located) starting at slot tₘ and spaced apart from slot tₘ with the interval Prx, the terminal device will determine whether resource 1, resource 2, resource 3, resource 4, resource 5 and resource 6 indicated by the “Time resource assignment” fields and “Frequency resource assignment” fields of the first sidelink control information received at slot tₘ and the first sidelink control information that is assumed to be received overlap with the resource R(x,y) or the series of periodic resources corresponding to the resource R(x,y). If there is an overlap and RSRP condition is met, the resource R(x,y) is excluded from the resource set A.

If the SL-RSRP measured by the terminal device is greater than the SL-RSRP threshold and the first sidelink control information detected by the terminal device does not includes the “Resource reservation period” field, the terminal device only determines whether the resources indicated by the “Time resource assignment” field and “Frequency resource assignment” field of the first sidelink control information received in slot tₘ overlap with the resource R(x,y) or the series of resources corresponding to the resource R(x,y). If there is an overlap, the resource R(x,y) is excluded from the resource set A.

For example, as illustrated in subfigure (b) of FIG. 5, if the terminal device detects the first sidelink control information in the PSCCH of slot tₘ, and the first sidelink control information does not include the “Resource reservation period” field, the terminal device determines whether resource 1, resource 2 and resource 3 indicated by the “Time resource assignment” field and “Frequency resource assignment” field of the first sidelink control information overlap with the resource R(x,y) or the series of periodic resources corresponding to the resource R(x,y). If there is an overlap and the RSRP condition is met, the resource R(x,y) is excluded from the resource set A.

If the remaining resources in the resource set A after the above resource exclusion are less than Mₜₒₜₐₗ×X, the SL-RSRP threshold is increased by 3 dB, and Step 1 is performed again. The physical layer reports the resource set A obtained after resource exclusion as a candidate resource set to the higher layer.

In Step 2, the higher layer randomly selects resources from the reported candidate resource set to send data. That is, the terminal device randomly selects resources from the candidate resource set to send data.

The following points should be noted.

1. The RSRP threshold is determined by the priority P1 carried in the PSCCH detected by the terminal device and the priority P2 of the data to be transmitted by the terminal device. The resource pool configuration used by the terminal device includes an SL-RSRP threshold table containing SL-RSRP thresholds corresponding to combinations of all the priorities. The resource pool configuration may be configured by the network or pre-configured.

For example, as illustrated in Table 1, it is assumed that values of the priority P1 and the priority P2 are both optionally selected from 0 to 7, the SL-RSRP thresholds corresponding to different combinations of priorities are represented by γᵢⱼ, where i in γᵢⱼ is a value of the priority P1 and j is a value of the priority P2.

TABLE 1
SL-RSRP Threshold Table

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

When the terminal device detects the PSCCH sent by other terminal device, and acquires the priority P1 carried in the first sidelink control information in the PSCCH and the priority P2 of the data to be transmitted, the terminal device determines the SL-RSRP threshold by looking up Table 1.

2. Whether measured PSCCH-RSRP or PSSCH-RSRP scheduled by the PSCCH is used by the terminal device for comparison with the SL-RSRP threshold depends on the resource pool configuration of the resource pool used by the terminal device. The resource pool configuration may be configured by network or pre-configured.

3. Regarding X, possible values for X may be {20, 35, 50}. The resource pool configuration used by the terminal device includes a correspondence between priorities and the above possible values. The terminal device determines the value of X according to the priority of the data to be transmitted and the correspondence. The resource pool configuration may be configured by the network or pre-configured.

4. Resource reservation periods are converted into logical slots.

As mentioned above, the terminal device transmits the first sidelink control information to indicate time-frequency resources, so as to reserve the resources that will be used next. During the resource selection of the terminal device, when performing sensing, the terminal device would decode the first sidelink control information sent by other terminal devices to obtain resources reserved by other terminal devices, and excludes the corresponding resources when selecting resources, thereby avoiding resource collision. During the resource selection of the terminal device, when performing resource exclusion, the terminal device would convert a physical time (e.g., 100 milliseconds) indicated by the “resource reservation period” field of the decoded first sidelink control information into a corresponding logical slot number, and then performs resource exclusion by utilizing the logical slot number:

$${P}_{rsvp}^{′} = ⌈ \frac{{T ′}_{max}}{10240 ms} \times {P}_{rsvp} ⌉ .$$

In the above formula, Pᵣₛᵥₚ is a resource reservation period. For example, Pᵣₛᵥₚ is the resource reservation period indicated by the “resource reservation period” field in the first sidelink control information detected by the terminal device, a resource reservation period allowed in a resource pool, or a resource reservation period of the terminal device. Pᵣₛᵥₚ is corresponding calculated logical slot number. T′ₘₐₓ is the number of slots belonging to the resource pool or transmit resource pool of the terminal device within a system frame number (SFN) or 10240 milliseconds.

The above has described an SL communication mode in NR-V2X, i.e., the terminal device autonomously selects transmission resources through resource sensing and autonomously transmits data on sidelink. The SL communication mode may also be applied to various SL communications such as direct communication between handheld terminals, and direct communication between pedestrians and vehicles.

5. Physical layer structure in LTE V2X

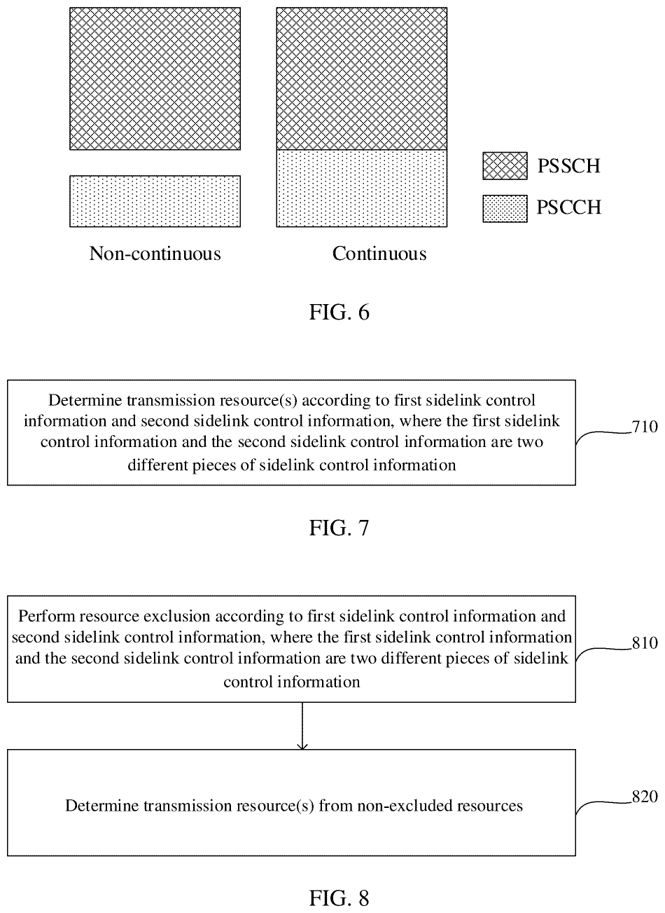

A structure of a physical layer for SL communication in the LTE V2X system is illustrated in FIG. 6. The PSCCH is configured to carry the second sidelink control information, and the PSSCH is configured to carry data. The PSCCH and the PSSCH are transmitted in the same subframe. In LTE V2X, the PSCCH and the PSSCH may be continuous or non-continuous in the frequency domain.

The above second sidelink control information is carried in the PSCCH, and mainly includes fields related to resource sensing, which is beneficial for other terminal devices to perform resource exclusion and resource selection after decoding.

In addition, the resource reservation and the sensing-based resource selecting method for the LTE V2X system are similar to those for the NR V2X system, which will not be repeated in the present application. Some brief descriptions are provided in below. In the LTE V2X system, the first to third information fields in the second sidelink control information are used to indicate retransmission resources in the same TB. Optionally, fourth information field in the second sidelink control information is used to indicate transmission resources in another TB. The first information field refers to “Frequency resource location of the initial transmission and retransmission” (i.e., a frequency domain resource location indication of initial transmission and retransmission) in the second sidelink control information. The second information field refers to “Time gap between initial transmission and retransmission” (i.e., a time interval between initial transmission and retransmission) in the second sidelink control information. The third information field refers to “Retransmission index” (i.e., a retransmission index) in the second sidelink control information. The fourth information field refers to “Resource reservation” (i.e., resource reservation) in the second sidelink control information.

At present, one of the research items in R18 sidelink standards is coexistence of LTE Sidelink and NR Sidelink on overlapping frequency bands. In the case where an LTE SL UE and an NR SL UE use an overlapping resource pool, how to avoid resource collision between them is not discussed in the standards.

In one aspect, the LTE SL UE is not capable of decoding sidelink control information from an NR SL UE, and therefore cannot obtain the resource reservation information from the NR SL UE, that is, the resource collision between the LTE SL UE and the NR SL UE cannot be avoided.

In another aspect, the NR SL UE may include both an LTE SL module and an NR SL module, and therefore is capable of decoding both sidelink control information from a LTE SL UE and sidelink control information from other NR SL UE. Thus, in this case, resource collision between the LTE SL UE and the NR SL UE may be avoided.

The present application focuses on how the NR SL UE performs resource exclusion based on the sidelink control information in LTE and the sidelink control information in NR, to avoid resource conflict between an LTE SL UE and an NR SL UE.

Technical solutions of the present application will be described through several exemplary embodiments in the following.

Reference is made to FIG. 7, which illustrates a flowchart of a resource determining method provided by an embodiment of the present application. The method may be applied to the network architecture shown in FIG. 1. For example, the method may be performed by a terminal device. The method may include the following step:

step 710: determining transmission resource(s) according to first sidelink control information and second sidelink control information, where the first sidelink control information and the second sidelink control information are two different pieces of sidelink control information.

Optionally, the first sidelink control information and the second sidelink control information are sidelink control information in two different communication systems. Optionally, the first sidelink control information is sidelink control information in the first communication system, the second sidelink control information is sidelink control information in the second communication system, and the first communication system and the second communication system are two different communication systems. For example, the first sidelink control information is sidelink control information in an NR system, and the second sidelink control information is sidelink control information in an LTE system or an evolved universal terrestrial radio access (E-UTRA) system. Certainly, that the first communication system is the NR system and that the second communication system is the LTE system or the E-UTRA system are only examples for illustration here, and the present application does not limit the first communication system and the second communication system, which may also be in other combinations.

Optionally, the first sidelink control information and the second sidelink control information are two pieces of sidelink control information with different functions. Optionally, the first sidelink control information has a first function, the second sidelink control information has a second function, and the first function and the second function are two different functions. For example, the first sidelink control information is used to schedule a PSSCH and third sidelink control information, and the second sidelink control information is used to schedule a PSSCH. The third sidelink control information is carried in the PSSCH, and the third sidelink control information mainly includes field(s) related to data demodulation so as to facilitate demodulation for data in the PSSCH by other terminal devices. Optionally, the third sidelink control information is 2nd-stage-SCI, i.e., the second-level SCI. Certainly, that the first function is a function of scheduling the PSSCH and the third sidelink control information and that the second function is a function of scheduling the PSSCH are only examples for illustration here, and the present application does not limit the first function and the second function, which may also be in other combinations.

Optionally, the first sidelink control information and the second sidelink control information are two pieces of sidelink control information in different formats. Optionally, the first sidelink control information is in a first format, the second sidelink control information is in a second format, and the first format and the second format are two different formats. For example, a format of the first sidelink control information is SCI format 1-A, and a format of the second sidelink control information is SCI format 1. Certainly, that the first format is SCI format 1-A and that the second format is SCI format 1 are only examples for illustration here, and the present application does not limit the first format and the second format, which may also be in other combinations.

Optionally, the first sidelink control information and the second sidelink control information are two pieces of sidelink control information including different fields. Optionally, the first sidelink control information includes a first field, the second sidelink control information includes a second field, and the first field and the second field are two different information fields. For example, the first sidelink control information includes a demodulation reference signal (DMRS) pattern indication field and a DMRS port quantity indication field, and the second sidelink control information includes a field for indicating a retransmission index and a time interval between an initial transmission and a retransmission. Certainly, that the first field includes the DMRS pattern indication field and the DMRS port quantity indication field and that the second field includes the field for indicating a retransmission index and a time interval between an initial transmission and a retransmission are only examples for illustration here, and the present application does not limit the first field and the second field, which may also be in other combinations.

Optionally, after determining the transmission resource(s) according to the first sidelink control information and the second sidelink control information, the terminal device may send data by using the transmission resource(s). For example, the terminal device determines a candidate resource set according to the first sidelink control information and the second sidelink control information, and then selects transmission resource(s) from the candidate resource set, and sends data by using the selected transmission resource(s). Optionally, the terminal device may select transmission resource(s) from the candidate resource set randomly or select transmission resource(s) according to a certain policy, which is not limited in the present application.

According to the technical solution provided in the embodiment of the present application, a terminal device determines transmission resource(s) according to first sidelink control information and second sidelink control information. Since the first sidelink control information and the second sidelink control information are two different pieces of sidelink control information, for example, sidelink control information in two different communication systems, an application of the technical solution may avoid resource conflict between a terminal device in a first communication system and other terminal devices in the first communication system or between a terminal device in a first communication system and a terminal device in a second communication device in a scenario in which resource pools in the two different communication systems overlap, thereby improving communication reliability.

Reference is made to FIG. 8, which illustrates a flowchart of a resource exclusion method provided by an embodiment of the present application. The method may be applied to the network architecture shown in FIG. 1. For example, the method may be performed by a terminal device. The method may include the following steps.

In step 810, resource exclusion is performed according to first sidelink control information and second sidelink control information, where the first sidelink control information and the second sidelink control information are two different pieces of sidelink control information.

For descriptions regarding the first sidelink control information and the second sidelink control information, reference may be made to the foregoing embodiment of FIG. 7, which will not be repeated in the embodiment.

In some embodiments, the step 810 includes: determining a resource selection window and resource sensing window(s), determining available resources in the resource selection window as an initialized resource set, and performing a resource exclusion step to exclude resource(s) in the resource set. The resource exclusion step includes a first exclusion step and a second exclusion step. The first exclusion step is used for resource exclusion based on the first sidelink control information detected in the resource sensing window(s), and the second exclusion step is used for resource exclusion based on the second sidelink control information detected in the resource sensing window(s).

In the embodiment of the present application, a time duration corresponding to the resource selection window is not limited. Exemplarily, the resource selection window may employ the design in the NR V2X system. For example, the resource selection window starts at n+T₁ and ends at n+T₂, the time unit n (e.g., slot n) is a time unit for triggering resource selection or reselection, or a time unit for the high layer to trigger the physical layer to report a candidate resource set, and descriptions regarding T₁ and T₂ may be referred to the above. Optionally, in the case where the first sidelink control information is sidelink control information in the NR system, the resource selection window may employ the design in the NR V2X system as described above.

Optionally, the quantity of resource sensing windows may be two or one.

Optionally, in the case where the quantity of the resource sensing windows are two, the resource sensing windows includes a first resource sensing window and a second resource sensing window. The terminal device detects the first sidelink control information in the first resource sensing window, and detects the second sidelink control information in the second resource sensing window. The first resource sensing window and the second resource sensing window are two different resource sensing windows. For example, a time duration corresponding to the first resource sensing window is different from a time duration corresponding to the second resource sensing window. Exemplarily, the first resource sensing window starts at n-T₀₀ and ends at n-T_{proc,0} (excluding n-T_{proc,0}), where T₀₀ is 1100 milliseconds or 100 milliseconds, and descriptions for T_{proc,0} may be referred to the foregoing descriptions. The second resource sensing window starts at n-T₁₀ and ends at n (excluding n), where T₁₀ is 1000 milliseconds, and the time unit n (e.g., slot n) is a time unit triggering resource selection or reselection or a time unit for the high layer to trigger the physical layer to report a candidate resource set. Optionally, in the case where the first sidelink control information is sidelink control information in the NR system, the first resource sensing window employs the design in the NR V2X system, for example, starting at n-T₀₀ and ending at n-T_{proc,0} (excluding n-T_{proc,0}). Optionally, in the case where the second sidelink control information is sidelink control information in the LTE system, the second resource sensing window employs the design in the LTE V2X system, i.e., starting at n-T₁₀ and ending at n (excluding n).

Optionally, in the case where the quantity of the resource sensing windows is one, as an example, the resource sensing window includes a first resource sensing window, and the terminal device detects the first sidelink control information and the second sidelink control information in the first resource sensing window. As another example, the resource sensing window includes a second resource sensing window, and the terminal device detects the first sidelink control information and the second sidelink control information in the second resource sensing window. The first resource sensing window and the second resource sensing window are two different resource sensing windows. For descriptions regarding the first resource sensing window and the second resource sensing window, reference may be made to the descriptions in the previous paragraph, which will be not repeated here.

Optionally, the first exclusion step is performed prior to the second exclusion step, or the first exclusion step is performed after the second exclusion step.

In some embodiments, the resource exclusion step further includes a third exclusion step, and the third exclusion step is used for resource exclusion based on unmonitored time unit(s) in the resource sensing window(s).

Optionally, in the case where the quantity of the resource sensing windows is one, the third exclusion step is used for resource exclusion based on unmonitored time unit(s) in the one resource sensing window. For example, in the case where the resource sensing window is the first resource sensing window, the third exclusion step is used to perform resource exclusion according to unmonitored time unit(s) in the first resource sensing window. As another example, in the case where the resource sensing window is the second resource sensing window, the third exclusion step is used to perform resource exclusion according to unmonitored time unit(s) in the second resource sensing window.

Optionally, in the case where the quantity of the resource sensing windows is two, for example, the resource sensing window includes the first resource sensing window and the second resource sensing window described above, the third exclusion step is used to perform resource exclusion according to the unmonitored time unit(s) in the first resource sensing window and the unmonitored time unit(s) in the second resource sensing window, i.e., perform resource exclusion according to unmonitored time unit(s) in an union of the first resource sensing window and the second resource sensing window; alternatively, the third exclusion step is used to perform resource exclusion according to the unmonitored time unit(s) in the first resource sensing window only; alternatively, the third exclusion step is used to perform resource exclusion according to the unmonitored time unit(s) in the second resource sensing window only.

In an exemplary embodiment, after determining the resource selection window and the resource sensing window(s), the terminal device performs the following steps (1) to (6):
(1) initializing, by the terminal device, all available resources in the resource selection window to a resource set A, any resource in the resource set A being denoted by R(x,y), where x and y represent a frequency domain location and a time domain location of the resource, respectively, and the quantity of initial resources in the resource set A being denoted by Mₜₒₜₐₗ;
(2) performing, by the terminal device, resource exclusion according to unmonitored time unit(s) in the resource sensing window(s), i.e., performing, by the terminal device, the third exclusion step;
(3) performing, by the terminal device, resource exclusion according to the first sidelink control information detected in the resource sensing window(s), i.e., performing, by the terminal device, the first exclusion step;
(4) performing, by the terminal device, resource exclusion according to the second sidelink control information detected in the resource sensing window(s), i.e., performing, by the terminal device, the second exclusion step;
(5) if the quantity of remaining resources in resource set A being less than Mₜₒₜₐₗ×X, increasing the RSRP threshold by 3 dB, and repeating the step (1), where X is configured by network or pre-configured; and
(6) selecting, by the terminal device, transmission resource(s) from the remaining resources in the resource set A randomly.

Optionally, the terminal device may skip performing step (2). Optionally, after performing the step (2), if the quantity of remaining resources in resource set A is less than Mₜₒₜₐₗ×X, the terminal device initializes the resource set A to the resource set A before step (2), and then performs subsequent steps.

Optionally, the order in which the terminal device performs steps (2), (3), and (4) may be adjustable. For example, step (2) is performed first, step (3) is performed next, and step (4) is performed finally. Alternatively, step (2) is performed first, step (4) is performed next, and then step (3) is performed.

Optionally, the third exclusion step includes: determining Q3 time units corresponding to the unmonitored time unit(s) according to resource reservation period(s) in a first resource reservation period set and/or second resource reservation period set and the unmonitored time unit(s), where Q3 is a positive integer; and in response that the Q3 time units overlap with a target resource in the resource set or a periodic resource corresponding to the target resource, excluding the target resource from the resource set.

For example, the target resource is resource R(x,y), and for the foregoing step (2), the terminal device determines corresponding Q3 time units according to each type of resource reservation period in the first resource reservation period set and/or the second resource reservation period set and the unmonitored time unit(s); and if the Q3 time units overlap with the resource R(x,y) or a series of periodic resources corresponding to the resource R(x,y), the terminal device excludes the resource R(x,y) from the resource set A.

Optionally, the first resource reservation period set includes one or more types of resource reservation periods allowed in a first communication system; alternatively, the first resource reservation period set includes one or more types of resource reservation periods allowed in the first communication system, and one or more types of resource reservation periods allowed in the second communication system. The first communication system is a communication system corresponding to the first sidelink control information, and the second communication system is a communication system corresponding to the second sidelink control information.

Optionally, the second resource reservation period set includes one or more types of resource reservation periods allowed in the second communication system, and the second communication system is a communication system corresponding to the second sidelink control information.

In a possible case, the third exclusion step includes: determining Q3 time units corresponding to the unmonitored time unit(s) according to resource reservation period(s) in the first resource reservation period set and the unmonitored time unit(s). A resource pool is configured with a resource reservation period set, e.g., the first resource reservation period set, and the first resource reservation period set includes one or more types of resource reservation periods allowed in the first communication system.

In another possible case, the third exclusion step includes: determining Q3 time units corresponding to the unmonitored time unit(s) according to resource reservation period(s) in the first resource reservation period set and the unmonitored time unit(s). A resource pool is configured with a resource reservation period set, e.g., the first resource reservation period set, and the first resource reservation period set includes one or more types of resource reservation periods allowed in the first communication system and one or more types of resource reservation periods allowed in the second communication system.

In still another possible case, the third exclusion step includes: determining Q3 time units corresponding to the unmonitored time unit(s) according to the unmonitored time unit(s) and resource reservation period(s) in the first resource reservation period set and the second resource reservation period set. A resource pool is configured with two resource reservation period sets, e.g., the first resource reservation period set and the second resource reservation period set, and the first resource reservation period set includes one or more types of resource reservation periods allowed in the first communication system, and the second resource reservation period set includes one or more types of resource reservation periods allowed in the second communication system.

For example, the first communication system is an NR system, and the second communication system is an LTE system.

Optionally, the first exclusion step includes: determining, according to a first time unit in which the first sidelink control information is detected and a resource reservation period indicated by the first sidelink control information, Q1 time units corresponding to the first time unit, and assuming that pieces of first sidelink control information with the same content are to be received in the Q1 time units, where Q1 is a positive integer; and in response that resources indicated by the first sidelink control information detected or assumed to be received overlap with a target resource in the resource set or a periodic resource corresponding to the target resource and a first RSRP threshold condition is met, excluding the target resource from the resource set. Alternatively, the first exclusion step includes: determining whether resources indicated by the detected first sidelink control information overlap with a target resource in the resource set or a periodic resource corresponding to the target resource; and in response that the resources indicated by the detected first sidelink control information overlap with the target resource in the resource set or the periodic resource corresponding to the target resource and the first RSRP threshold condition is met, excluding the target resource from the resource set.

For example, the target resource is a resource R(x,y), and for the foregoing step (3), the terminal device determines the corresponding Q1 time units according to the time unit where first sidelink control information is detected and the resource reservation period indicated by the first sidelink control information, assumes that pieces of first sidelink control information with the same content are to be received in the Q1 time units, and excludes the resource R(x,y) from the resource set A if resources indicated by “Time resource assignment” and “Frequency resource assignment” in the foregoing detected first sidelink control information or assumed to-be-received first sidelink control information overlap with the resource R(x,y) or a series of periodic resources corresponding to the resource R(x,y) and the first RSRP threshold condition is met. Alternatively, the terminal device determines whether resources indicated by “Time resource assignment” and “Frequency resource assignment” in the detected first sidelink control information overlap with the resource R(x,y) or a series of periodic resources corresponding to the resource R(x,y), and if these resources overlap with the resource R(x,y) or the series of periodic resources corresponding to the resource R(x,y), the terminal device excludes the resource R(x,y) from the resource set A. Meeting the first RSRP threshold condition refers to that an RSRP of a PSCCH where the first sidelink control information is located or an RSRP of a PSSCH scheduled by the PSCCH is greater than a first RSRP threshold. The first RSRP threshold may be determined according to a priority indicated by the first sidelink control information and a priority of to-be-transmitted data of the terminal device.

Optionally, the second exclusion step includes: determining, according to a second time unit in which the second sidelink control information is detected and a resource reservation period indicated by the second sidelink control information, Q2 time units corresponding to the second time unit; assuming that pieces of second sidelink control information with the same content are to be received in the Q2 time units, where Q2 is a positive integer; and in response that resources indicated by the second sidelink control information detected or assumed to be received overlap with a target resource in the resource set or a periodic resource corresponding to the target resource and a second RSRP threshold condition is met, excluding the target resource from the resource set.

For example, the target resource is resource R(x,y), and for the foregoing step (4), the terminal device determines the corresponding Q2 time units according to the time unit where the second sidelink control information is detected and the resource reservation period indicated by the second sidelink control information, assumes that pieces of second sidelink control information with the same content are to be received in the Q2 time units, and excludes the resource R(x,y) from the resource set A if the resources indicated by a first to a third information field in the foregoing detected second sidelink control information or assumed to-be-received second sidelink control information overlap with the resource R(x,y) or a series of periodic resources corresponding to the resource R(x,y) and a second RSRP threshold condition is met. Meeting the second RSRP threshold condition refers to that an RSRP of a PSSCH scheduled by the detected second sidelink control information is greater than a second RSRP threshold. The second RSRP threshold may be determined according to a priority indicated by the second sidelink control information and a priority of to-be-transmitted data of the terminal device. In addition, the first information field refers to “Frequency resource location of the initial transmission and retransmission” (i.e., a frequency domain resource location indication of initial transmission and retransmission) in the second sidelink control information, the second information field refers to “Time gap between initial transmission and retransmission” (i.e., a time interval between initial transmission and retransmission) in the second sidelink control information, and the third information field refers to “Retransmission index” (i.e., a retransmission index) in the second sidelink control information.

Optionally, the same RSRP threshold table is configured for the first exclusion step and the second exclusion step. For example, the same RSRP threshold table may be configured for step (3) and step (4) by way of configuring by network or pre-configuring, which includes RSRP thresholds corresponding to all priority combinations. The first RSRP threshold is determined by way of table look-up according to a priority indicated by the first sidelink control information and a priority of to-be-transmitted data. The second RSRP threshold is determined by way of table look-up according to a priority indicated by the second sidelink control information and the priority of to-be-transmitted data. Accordingly, 3 dB boosting of RSRP thresholds refers to that the RSRP threshold corresponding to each priority combination is increased by 3 dB.

Optionally, different RSRP threshold tables are configured for the first exclusion step and the second exclusion step. For example, different RSRP threshold tables may be configured for step (3) and step (4) by way of configuring by network or pre-configuring, which are denoted as a first RSRP threshold table and a second RSRP threshold table, respectively. The first RSRP threshold is determined by looking up the first RSRP threshold table according to the priority indicated by the first sidelink control information and the priority of the to-be-transmitted data. Similarly, the second RSRP threshold is determined by looking up the second RSRP threshold table according to the priority indicated by the second sidelink control information and the priority of the to-be-transmitted data. Accordingly, 3 dB boosting of RSRP thresholds refers to that a RSRP threshold corresponding to each priority combinations in the first RSRP threshold table and the second RSRP threshold table is increased by 3 dB.

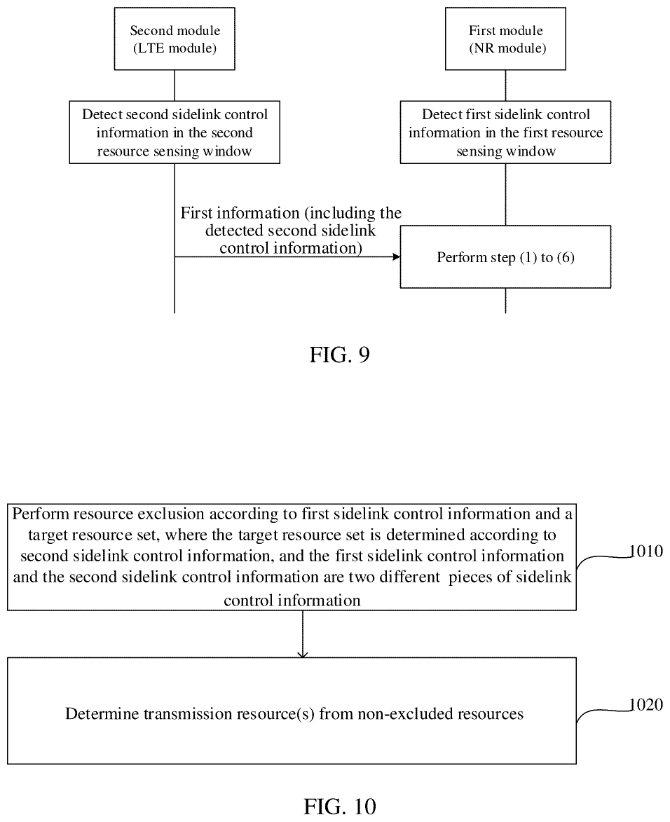

In an exemplary embodiment, as shown in FIG. 9, the above steps are described from the perspective of internal modules of the terminal device. The terminal device includes a first module and a second module, and the first module and the second module are two different functional modules. For example, the first module is an NR module, and the second module is an LTE module. Optionally, the LTE module detects second sidelink control information in the second resource sensing window. The LTE module sends first information to the NR module, which includes the detected second sidelink control information. Optionally, the first information further includes at least one of: a corresponding time unit (e.g., a subframe, or a slot) in which the second sidelink control information is detected, an RSRP of a PSSCH scheduled by the detected second sidelink control information, a second resource reservation period set, a subframe or a slot set that may belong to a resource pool, Pstep (used for a conversion from a resource reservation period to a logical slot in the second communication system, and determined according to a time division duplexing (TDD) configuration), a TDD configuration (including an uplink-downlink configuration, e.g., a ratio of an uplink subframe to a downlink subframe), or a resource pool frequency domain resource configuration of the detected second sidelink control information (e.g., a resource pool frequency domain start point, a width of a sub-channel in a resource pool, and a quantity of sub-channels in a resource pool). The NR module detects the first sidelink control information in the first resource sensing window, and performs the steps (1) to (6) introduced above. When performing step (4), the NR module excludes resources by using the first information.

In an exemplary embodiment, as shown in FIG. 8, after step 810, the method further includes the following step 820:
step 820: determining transmission resource(s) from non-excluded resources.

Optionally, the terminal device determines the non-excluded resources as a candidate resource set, then selects transmission resource(s) from the candidate resource set, and sends data using the selected transmission resource(s).

Optionally, the resource exclusion step is performed by a physical layer; for example, the physical layer performs the resource exclusion step to obtain a candidate resource set, and then the physical layer reports the candidate resource set to a higher layer, and the higher layer selects transmission resource(s) from the candidate resource set to transmit data.

It should be noted that the term “time unit(s)” mentioned in the embodiments of the present application may be slot(s), or may be subframe(s), or other time units, which is not limited in the present application.

According to the technical solution provided in the embodiments of the present application, the terminal device performs resource exclusion according to the first sidelink control information and the second sidelink control information. Since the first sidelink control information and the second sidelink control information are two different pieces of sidelink control information, for example, sidelink control information in two different communication systems, an application of such the technical solution may avoid resource conflict between a terminal device in a first communication system and other terminal devices in the first communication system or between the terminal device in the first communication system and a terminal device in a second communication device in a scenario in which resource pools in the two different communication systems overlap, thereby improving communication reliability.

Reference is made to FIG. 10, which illustrates a flowchart of a resource exclusion method according to another embodiment of the present application. The method may be applied to the network architecture shown in FIG. 1. For example, the method may be performed by a terminal device. The method may include the following step.

In step 1010, resource exclusion is performed according to first sidelink control information and a target resource set, where the target resource set is determined according to second sidelink control information, and the first sidelink control information and the second sidelink control information are two different pieces of sidelink control information.

For descriptions regarding the first sidelink control information and the second sidelink control information, reference may be made to the foregoing embodiment of FIG. 7, which will not be repeated in the embodiment.

In some embodiments, the foregoing step 1010 includes: determining a first resource selection window and a first resource sensing window, determining available resources in the first resource selection window as an initialized first resource set, and performing a first resource exclusion step to exclude resource(s) from the first resource set. The first resource exclusion step includes a fourth exclusion step and a fifth exclusion step. The fourth exclusion step is used for resource exclusion based on the first sidelink control information detected in the first resource sensing window, and the fifth exclusion step is used for resource exclusion based on the target resource set.

In the embodiments of the present application, a time duration corresponding to the first resource selection window is not limited. Exemplarily, the first resource selection window may employ the design in the NR V2X system. For example, the first resource selection window starts at n+T₁ and ends at n+T₂, the time unit n (e.g., slot n) is a time unit for triggering resource selection or reselection or a time unit for the high layer to trigger the physical layer to report a candidate resource set, and descriptions regarding T₁ and T₂ may be referred to the above. Optionally, in the case where the first sidelink control information is sidelink control information in the NR system, the first resource selection window may employ the design in the NR V2X system as described above.

In the embodiments of the present application, a time duration corresponding to the first resource sensing window is not limited. Exemplarily, the first resource sensing window may employ the design in the NR V2X system. For example, the first resource sensing window starts at n-T₀₀ and ends at n-T_{proc,0} (excluding n-T_{proc,0}), where T₀₀ is 1100 milliseconds or 100 milliseconds, descriptions for T_{proc,o} may be referred to the foregoing descriptions, and the time unit n (e.g., time slot n) is a time unit triggering resource selection or reselection or a time unit for the high layer to trigger the physical layer to report a candidate resource set. Optionally, in the case where the first sidelink control information is sidelink control information in the NR system, the first resource sensing window may employ the design in the NR V2X system as described above.

Optionally, the fourth exclusion step is performed prior to the fifth exclusion step, or the fourth exclusion step is performed after the fifth exclusion step.

In some embodiments, the first resource exclusion step further includes a sixth exclusion step, and the sixth exclusion step is used for resource exclusion based on unmonitored time unit(s) in the first resource sensing window.

Optionally, after performing the fifth exclusion step, if the quantity of remaining resources in the first resource set is less than or equal to a threshold, the terminal device initializes the first resource set to the first resource set obtained before performing the fifth exclusion step.

In an exemplary embodiment, after determining the first resource selection window and the first resource sensing window, the terminal device performs the following steps (1) to (6):
(1) initializing, by the terminal device, all available resources in the first resource selection window to a resource set A, any resource in resource set A being denoted by R(x,y), where x and y represent a frequency domain location and a time domain location of the resource, respectively, and the quantity of initial resources in the resource set A being denoted by Mₜₒₜₐₗ;
(2) performing, by the terminal device, resource exclusion according to unmonitored time unit(s) in the first resource sensing window, i.e., performing, by the terminal device, the sixth exclusion step;
(3) performing, by the terminal device, resource exclusion according to the first sidelink control information detected in the first resource sensing window, i.e., performing, by the terminal device, the fourth exclusion step;
(4) performing, by the terminal device, resource exclusion according to the target resource set, i.e., performing, by the terminal device, the fifth exclusion step;
(5) if the quantity of remaining resources in the resource set A is less than Mₜₒₜₐₗ×X, increasing the RSRP threshold by 3 dB, and repeating step (1), where X is configured by network or pre-configured; and
(6) selecting, by the terminal device, transmission resource(s) from the remaining resources in the resource set A randomly.

Optionally, the terminal device may skip performing step (2). Optionally, after performing step (2), if the quantity of remaining resources in resource set A is less than Mₜₒₜₐₗ×X, the terminal device initializes the resource set A to the resource set A before step (2), and then performs subsequent steps.

Optionally, after performing step (4), if the quantity of remaining resources in the resource set A is less than Mₜₒₜₐₗ×X, the terminal device initializes the resource set A to the resource set A obtained before step (2), and then performs subsequent steps.

Optionally, the order in which the terminal device performs steps (2), (3), and (4) may be adjustable. For example, step (2) is performed first, step (3) is performed next, and step (4) is performed finally. Alternatively, step (2) is performed first, step (4) is performed next, and then step (3) is performed.

Optionally, the sixth exclusion step includes: determining Q6 time units corresponding to the unmonitored time unit(s) in the first resource sensing window according to resource reservation period(s) in a first resource reservation period set and the unmonitored time unit(s) in the first resource sensing window, where Q6 is a positive integer; and in response that the Q6 time units overlap with a first resource in the first resource set or a periodic resource corresponding to the first resource, excluding the first resource from the first resource set.

For example, the first resource is the resource R(x,y), and for the foregoing step (2), the terminal device determines corresponding Q6 time units according to each type of resource reservation period in the first resource reservation period set and the unmonitored time unit(s); and if the Q6 time units overlap with the resource R(x,y) or a series of periodic resources corresponding to the resource R(x,y), the terminal device excludes the resource R(x,y) from the resource set A.

Optionally, the first resource reservation period set includes one or more types of resource reservation periods allowed in a first communication system, and the first communication system is a communication system corresponding to the first sidelink control information. Exemplarily, the first communication system is an NR system.

Optionally, the fourth exclusion step includes: determining, according to a first time unit in which the first sidelink control information is detected and a resource reservation period indicated by the first sidelink control information, Q4 time units corresponding to the first time unit; assuming that pieces of first sidelink control information with the same content are to be received in the Q4 time units, where Q4 is a positive integer; and in response that resources indicated by first sidelink control information detected or assumed to be received overlap with a first resource in the first resource set or a periodic resource corresponding to the first resource and a first RSRP threshold condition is met, excluding the first resource from the first resource set. Alternatively, the fourth exclusion step includes: determining whether resources indicated by the detected first sidelink control information overlap with a first resource in the first resource set or a periodic resource corresponding to the first resource; and in response that the resources indicated by the detected first sidelink control information overlap with the first resource in the first resource set or the periodic resource corresponding to the first resource and the first RSRP threshold condition is met, excluding the first resource from the first resource set.

For example, the first resource is the resource R(x,y), and for the foregoing step (3), the terminal device determines the corresponding Q4 time units according to the time unit where the first sidelink control information is detected and the resource reservation period indicated by the first sidelink control information, assumes that pieces of first sidelink control information with the same content are to be received in the Q4 time units, and excludes the resource R(x,y) from the resource set A if the resources indicated by “Time resource assignment” and “Frequency resource assignment” in the foregoing detected first sidelink control information or assumed to-be-received first sidelink control information overlap with the resource R(x,y) or a series of periodic resources corresponding to the resource R(x,y) and the first RSRP threshold condition is met. Alternatively, the terminal device determines whether resources indicated by “Time resource assignment” and “Frequency resource assignment” in the detected first sidelink control information overlap with R(x,y) or a series of periodic resources corresponding to the resource R(x,y), and if these resources overlap with R(x,y) or the series of periodic resources corresponding to the resource R(x,y), the terminal device excludes the resource R(x,y) from the resource set A. Meeting the first RSRP threshold condition refers to that an RSRP of a PSCCH where the first sidelink control information is located or an RSRP of a PSSCH scheduled by the PSCCH is greater than a first RSRP threshold. The first RSRP threshold may be determined according to a priority indicated by the first sidelink control information and a priority of to-be-transmitted data of the terminal device.

Optionally, a first RSRP threshold table is configured for the fourth exclusion step. For example, by way of configuring by network or pre-configuring, the first RSRP threshold table may be configured for step (3), which includes RSRP thresholds corresponding to all priority combinations. The first RSRP threshold is determined by way of looking up the first RSRP threshold table according to the priority indicated by the first sidelink control information and the priority of the to-be-transmitted data. Accordingly, 3 dB boosting of RSRP thresholds refers to that the RSRP threshold corresponding to each priority combination in the first RSRP threshold table is increased by 3 dB.

Optionally, the target resource set includes resource(s) excluded according to the second sidelink control information. In this case, the fifth exclusion step includes: in response that a first resource in the first resource set overlaps with a resource in the target resource set, excluding the first resource from the first resource set. In an example, if the first resource in the first resource set belongs to the target resource set, the first resource is excluded from the first resource set. For example, the target resource set includes resource(s) excluded according to the second sidelink control information, the first resource is the resource R(x,y), and for the foregoing step (4), if the resource R(x,y) belongs to the target resource set, the resource R(x,y) is excluded from the resource set A.

Optionally, the target resource set includes remaining resource(s) obtained after exclusion based on the second sidelink control information. In this case, the fifth exclusion step includes: in response that the first resource in the first resource set does not belong to the target resource set, excluding the first resource from the first resource set. For example, the target resource set includes the remaining resource(s) obtained after exclusion based on the second sidelink control information, the first resource is the resource R(x,y), and for the foregoing step (4), if the resource R(x,y) does not belong to the target resource set, the resource R(x,y) is excluded from the resource set A.

Optionally, the target resource set is determined according to the second sidelink control information, and the terminal device performs the following steps to determine the target resource set based on the second sidelink control information: determining a second resource selection window and a second resource sensing window; determining available resources in the second resource selection window as an initialized second resource set; performing a second resource exclusion step to exclude resource(s) from the second resource set; and determining the target resource set according to excluded or remaining resource(s) in the second resource exclusion step. The second resource exclusion step includes a seventh exclusion step, and the seventh exclusion step is used for resource exclusion based on the second sidelink control information detected in the second resource sensing window.

In the embodiments of the present application, a time duration corresponding to the second resource selection window is not limited. In an example, the second resource selection window is the same as the first resource selection window, for example, the first resource selection window and the second resource selection window both start at n+T₁ and end at n+T₂, the time unit n (e.g., slot n) is a time unit for triggering resource selection or reselection or a time unit for the high layer to trigger the physical layer to report a candidate resource set, and descriptions regarding T₁ and T₂ may be referred to the description in the above resource selection method in NR V2X sensing. In another example, the second resource selection window is different from the first resource selection window. For example, the first resource selection window employs the design in the NR V2X system, and the second resource selection window employs the design in the LTE V2X system. For the first resource selection window employing the design in the NR V2X system, the first resource selection window may start at n+T₁ and end at n+T₂, the time unit n (e.g., slot n) is a time unit for triggering resource selection or reselection or a time unit for the high layer to trigger the physical layer to report a candidate resource set, and descriptions regarding T₁ and T₂ may be referred to the description about resource selection window in the NR V2X system. For the second resource selection window employing the design in the LTE V2X system, the second resource selection window may start at n+T₁ and end at n+T₂, the time unit n (e.g., slot n) is a time unit for triggering resource selection or reselection or a time unit for the high layer to trigger the physical layer to report a candidate resource set. In the LTE V2X system, T₁≤4, if T₂ₘᵢₙ is configured by the higher layer, T₂ₘᵢₙ≤T_{2≤100}; otherwise, 20≤T₂≤100. T₂ₘᵢₙ is related to a priority of to-be-transmitted data of the terminal device, and moreover, T₂ is required to meet delay requirement of a service; for example, in the case where packet delay budget (PDB) is less than 100 milliseconds, T₂ shall be less than or equal to PDB. In the case where the foregoing condition is met, values of T₁ and T₂ depend on the implementation of the terminal device. Optionally, the PDB is a remaining PDB, i.e., a remaining delay budget of a data packet.

In the embodiments of the present application, a time duration corresponding to the second resource sensing window is not limited. In an example, the second resource sensing window is the same as the first resource sensing window; for example, the first resource sensing window and the second resource sensing window both start at n-T₀₀ to n-T_{proc,0} (excluding n-T_{proc,0}), where Too is 1100 milliseconds or 100 milliseconds, descriptions for T_{proc,o} may be referred to the foregoing descriptions, and the time unit n (e.g., time slot n) is a time unit triggering resource selection or reselection or a time unit for the high layer to trigger the physical layer to report a candidate resource set. In another example, the second resource sensing window is different from the first resource sensing window. For example, the first resource sensing window starts at n-T₀₀ and ends at n-T_{proc,0} (excluding n-T_{proc,0}), where T₀₀ is 1100 milliseconds or 100 milliseconds, descriptions for T_{proc,0} may be referred to the foregoing descriptions. The second resource sensing window starts at n-T₁₀ and ends at n (excluding n), where T₁₀ is 1000 milliseconds, and the time unit n (e.g., time slot n) is a time unit triggering resource selection or reselection or a time unit for the high layer to trigger the physical layer to report a candidate resource set.

Optionally, the second resource exclusion step further includes an eighth exclusion step, and the eighth exclusion step is used for resource exclusion based on unmonitored time unit(s) in the second resource sensing window.

In an exemplary embodiment, after determining the second resource selection window and the second resource sensing window, the terminal device performs the following steps (7) to (10):
(7) initializing, by the terminal device, all available resources in the second resource selection window to a resource set A, any resource in the resource set A being denoted by R(x,y), where x and y represent a frequency domain location and a time domain location of the resource, respectively, and the quantity of initial resources in the resource set A is denoted by Mₜₒₜₐₗ;
(8) performing, by the terminal device, resource exclusion according to unmonitored time unit(s) in the second resource sensing window, i.e., the terminal device performing the eighth exclusion step;
(9) performing, by the terminal device, resource exclusion according to the second sidelink control information detected in the second resource sensing window, i.e., the terminal device performing the seventh exclusion step; and
(10) in response that the quantity of remaining resources in the resource set A is less than Mₜₒₜₐₗ×X, RSRP threshold is increased by 3 dB, and repeating step (7), where X is configured by network or pre-configured, or is a preset value specified in standards, for example, X is 0.2.

Optionally, the terminal device may skip performing step (8).

Optionally, the eighth exclusion step includes: determining Q8 time units corresponding to the unmonitored time unit(s) in the second resource sensing window according to resource reservation period(s) in a second resource reservation period set and the unmonitored time unit(s) in the second resource sensing window, where Q8 is a positive integer; and in response that the Q8 time units overlap with a second resource in the second resource set or a periodic resource corresponding to the second resource, excluding the second resource from the second resource set.

For example, the second resource is the resource R(x,y), and for the foregoing step (8), the terminal device determines corresponding Q8 time units according to each type of resource reservation period in the second resource reservation period set and the unmonitored time unit(s); and if the Q8 time units overlap with the resource R(x,y) or a series of periodic resources corresponding to the resource R(x,y), the terminal device excludes resource R(x,y) from the resource set A.

Optionally, the second resource reservation period set includes one or more types of resource reservation periods allowed in a second communication system, and the second communication system is a communication system corresponding to the second sidelink control information. Exemplarily, the second communication system is an LTE system.

Optionally, the seventh exclusion step includes: determining, according to a second time unit in which the second sidelink control information is detected and a resource reservation period indicated by the second sidelink control information, Q7 time units corresponding to the second time unit; assuming that pieces of second sidelink control information with the same content are to be received in the Q7 time units, where Q7 is a positive integer; and in response that resources indicated by second sidelink control information detected or assumed to be received overlap with a second resource in the second resource set or a periodic resource corresponding to the second resource and a second RSRP threshold condition is met, excluding the second resource from the second resource set.

For example, the second resource is the resource R(x,y), and for the foregoing step (9), the terminal device determines the corresponding Q7 time units according to the time unit where the second sidelink control information is detected and the resource reservation period indicated by the second sidelink control information, assumes that pieces of second sidelink control information with the same content are to be received in the Q7 time units, and excludes the resource R(x,y) from the resource set A if resources indicated by a first to a third information fields in the foregoing detected second sidelink control information and assumed to-be-received second sidelink control information overlap with the resource R(x,y) or a series of periodic resources corresponding to the resource R(x,y), and a second RSRP threshold condition is met. Meeting the second RSRP threshold condition refers to that an RSRP of a PSSCH scheduled by the detected second sidelink control information is greater than a second RSRP threshold. The second RSRP threshold may be determined according to a priority indicated by the second sidelink control information and a priority of to-be-transmitted data of the terminal device. In addition, the first information field refers to “Frequency resource location of the initial transmission and retransmission” (i.e., a frequency domain resource location indication of initial transmission and retransmission) in the second sidelink control information, the second information field refers to “Time gap between initial transmission and retransmission” (i.e., a time interval between initial transmission and retransmission) in the second sidelink control information, and the third information field refers to “Retransmission index” (i.e., a retransmission index) in the second sidelink control information.

Optionally, a second RSRP threshold table is configured for the seventh exclusion step. For example, the second RSRP threshold table may be configured for step (9) by way of configuring by network or pre-configuring, which includes RSRP thresholds corresponding to all priority combinations. The second RSRP threshold is determined by way of looking up the second table according to a priority indicated by the second sidelink control information and a priority of to-be-transmitted data. Accordingly, 3 dB boosting of RSRP thresholds refers to that the RSRP threshold corresponding to each priority combination in the second RSRP threshold table is increased by 3 dB.

Optionally, the same RSRP threshold table is configured for the fourth exclusion step and the seventh exclusion step, that is, the first RSRP threshold table and the second RSRP threshold table are the same. Alternatively, different RSRP threshold tables are configured for the fourth exclusion step and the seventh exclusion step, that is, the first RSRP threshold table and the second RSRP threshold table are different.

Optionally, determining the target resource set according to excluded or remaining resource(s) in the second resource exclusion step includes any one of the following cases 1 to 4.

Case 1: the second resource set obtained after the second resource exclusion step is determined as the target resource set.

Case 2: a first quantity of resources with a lowest signal strength indicator (RSSI) in the second resource set obtained after the second resource exclusion step are determined as the target resource set. For example, for any resource R(x,y) remaining in the resource set A obtained after the second resource exclusion step, a RSSI measurement value or an average RSSI measurement value corresponding to the resource R(x,y) is calculated, and Mₜₒₜₐₗ×Y resources with the lowest RSSI or the lowest average RSSI are determined as the target resource set. Y is configured by network or pre-configured, or is a preset value specified in standards, for example, Y is 0.2.

Case 3: resource(s) excluded in the second resource exclusion step are determined as the target resource set, or in other words, resource(s) in the second resource set that overlap with resource(s) indicated by the second sidelink control information and meet the second RSRP threshold condition are determined as the target resource set.

Case 4: a difference set between the initialized second resource set and a third resource set is determined as the target resource set. The third resource set includes a first quantity of resources with a lowest RSSI in the second resource set obtained after the second resource exclusion step. For example, for any resource R(x,y) remaining in the resource set A obtained after the second resource exclusion step, a RSSI measurement value or an average RSSI measurement value corresponding to the resource R(x,y) is calculated, and Mₜₒₜₐₗ×Y resources with the lowest RSSI or average RSSI are determined as the resource set B (i.e., the third resource set), and a difference set between the initialized resource set A and the resource set B is determined as the target resource set.

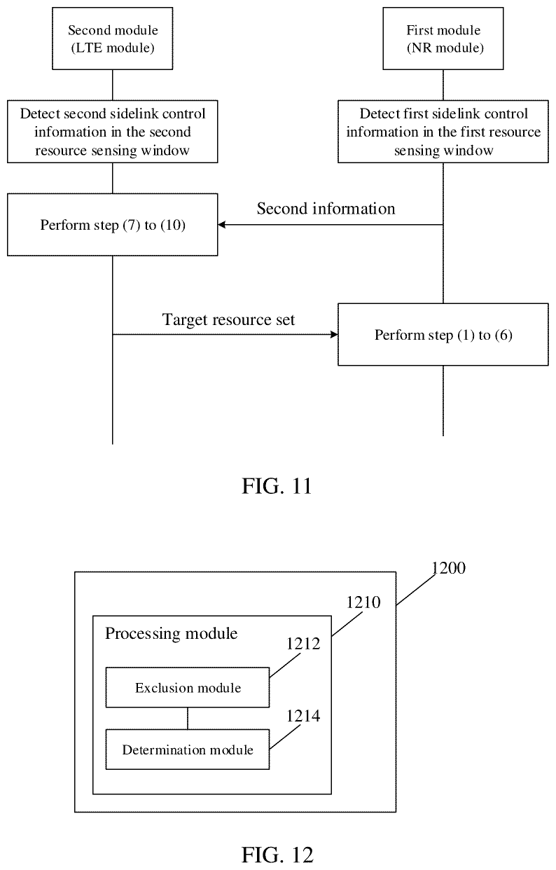

In an exemplary embodiment, as shown in FIG. 11, the above steps are described from the perspective of internal modules of the terminal device. The terminal device includes a first module and a second module, and the first module and the second module are two different functional modules. For example, the first module is an NR module, and the second module is an LTE module. Optionally, the LTE module detects the second sidelink control information in the second resource sensing window, and the NR module detects the first sidelink control information in the first resource sensing window. The NR module sends second information to the LTE module, and the second information includes at least one of the following: a time unit (e.g., a slot) in which the higher layer triggers the physical layer to report a candidate resource set, a priority of to-be-transmitted data, a resource reservation period of the to-be-transmitted data, resource selection window related parameters, resource pool frequency domain resource configuration parameters (e.g., a resource pool frequency domain start point, a quantity of sub-channels included in a resource pool, and a sub-channel width). The LTE module performs the foregoing steps (7) to (10) by using the second information to determine the target resource set, and sends the target resource set to the NR module. The NR module performs the foregoing steps (1) to (6), and excludes resources by using the target resource set when performing step (4).

In an exemplary embodiment, as shown in FIG. 10, after step 1010, the method further includes the following step 1020:
step 1020: determining transmission resource(s) from non-excluded resources.

Optionally, the terminal device determines non-excluded resources as a candidate resource set, then selects transmission resource(s) from the candidate resource set, and sends data by using selected transmission resource(s).

Optionally, the resource exclusion step is performed by a physical layer; for example, the physical layer performs the resource exclusion step to obtain a candidate resource set, and then the physical layer reports the candidate resource set to a higher layer, and the higher layer selects transmission resource(s) from the candidate resource set to transmit data.

It should be noted that the term “time unit(s)” mentioned in the embodiments of the present application may be slot(s), or subframe(s), or other time units, which is not limited in the present application.

According to the technical solution provided in the embodiments of the present application, the terminal device performs resource exclusion according to the first sidelink control information and the target resource set determined based on the second sidelink control information. Since the first sidelink control information and the second sidelink control information are two different pieces of sidelink control information, for example, sidelink control information in two different communication systems, an application of such the technical solution may avoid resource conflict between a terminal device in a first communication system and other terminal devices in the first communication system or between a terminal device in a first communication system and a terminal device in a second communication device in a scenario in which resource pools in the two different communication systems overlap, thereby improving communication reliability.

The following are apparatus embodiments of the present application, and may be configured to perform the method provided by the embodiments of the present application. For details not disclosed in the apparatus embodiments of the present application, reference is made to the method embodiments of the present application.

Reference is made to FIG. 12, which illustrates a flowchart of a resource determining apparatus provided by an embodiment of the present application. The apparatus has a function of implementing the foregoing method examples, and the function may be implemented by hardware, or may be implemented by executing corresponding software by hardware. The apparatus may be the terminal device described above, or may be installed in the terminal device. As shown in FIG. 12, the apparatus 1200 may include a processing module 1210.

The processing module 1210 is configured to determine a transmission resource according to first sidelink control information and second sidelink control information. The first sidelink control information and the second sidelink control information are two different pieces of sidelink control information.

In some embodiments, the first sidelink control information is sidelink control information in an NR system, and the second sidelink control information is sidelink control information in an LTE system.

In an exemplary embodiment, the processing module 1210 includes an exclusion module 1212 and a determination module 1214.

The exclusion module 1212 is configured to perform resource exclusion according to the first sidelink control information and the second sidelink control information.

The determination module 1214 is configured to determine the transmission resource from non-excluded resources.

The exclusion module 1212 is configured to perform resource exclusion according to the first sidelink control information and the second sidelink control information. The first sidelink control information and the second sidelink control information are two different pieces of sidelink control information.

In some embodiments, the exclusion module 1212 is configured to:
determine a resource selection window and resource sensing window(s);
determine available resources in the resource selection window as an initialized resource set; and
perform a resource exclusion step to exclude resource(s) from the resource set; where the resource exclusion step includes a first exclusion step and a second exclusion step, the first exclusion step is used for resource exclusion based on the first sidelink control information detected in the resource sensing window(s), and the second exclusion step is used for resource exclusion based on the second sidelink control information detected in the resource sensing window(s).

In some embodiments, the first exclusion step is performed prior to the second exclusion step, or the first exclusion step is performed after the second exclusion step.

In some embodiments, the resource exclusion step further includes a third exclusion step, and the third exclusion step is used for resource exclusion based on unmonitored time unit(s) in the resource sensing window(s).

In some embodiments, the third exclusion step includes:
determining Q3 time units corresponding to the unmonitored time unit(s) according to resource reservation period(s) in a first resource reservation period set and/or second resource reservation period set and the unmonitored time unit(s), where Q3 is a positive integer; and
in response that the Q3 time units overlap with a target resource in the resource set or a periodic resource corresponding to the target resource, excluding the target resource from the resource set.

In some embodiments, the first resource reservation period set includes one or more types of resource reservation periods allowed in a first communication system;
alternatively, the first resource reservation period set includes one or more types of resource reservation periods allowed in the first communication system and one or more types of resource reservation periods allowed in a second communication system;
where the first communication system is a communication system corresponding to the first sidelink control information, and the second communication system is a communication system corresponding to the second sidelink control information.

In some embodiments, the second resource reservation period set includes one or more types of resource reservation periods allowed in a second communication system, and the second communication system is a communication system corresponding to the second sidelink control information.

In some embodiments, the first exclusion step includes:
determining, according to a first time unit in which the first sidelink control information is detected and a resource reservation period indicated by the first sidelink control information, Q1 time units corresponding to the first time unit, and assuming that pieces of first sidelink control information with the same content are to be received in the Q1 time units, where Q1 is a positive integer; and in response that resources indicated by the first sidelink control information detected or assumed to be received overlap with a target resource in the resource set or a periodic resource corresponding to the target resource and a first reference signal received power (RSRP) threshold condition is met, excluding the target resource from the resource set; or
determining whether resources indicated by the detected first sidelink control information overlap with a target resource in the resource set or a periodic resource corresponding to the target resource; and in response that the resources indicated by the detected first sidelink control information overlap with the target resource in the resource set or the periodic resource corresponding to the target resource and the first RSRP threshold condition is met, excluding the target resource from the resource set.

In some embodiments, the second exclusion step includes:
determining, according to a second time unit in which the second sidelink control information is detected and a resource reservation period indicated by the second sidelink control information, Q2 time units corresponding to the second time unit; assuming that pieces of second sidelink control information with the same content are to be received in the Q2 time units, where Q2 is a positive integer; and in response that resources indicated by second sidelink control information detected or assumed to be received overlap with a target resource in the resource set or a periodic resource corresponding to the target resource and a second RSRP threshold condition is met, excluding the target resource from the resource set.

In some embodiments, a same RSRP threshold table is configured for the first exclusion step and the second exclusion step; or different RSRP threshold tables are configured for the first exclusion step and the second exclusion step.

In some embodiments, the resource sensing window(s) include a first resource sensing window and a second resource sensing window;
the terminal device detects the first sidelink control information in the first resource sensing window and the second sidelink control information in the second resource sensing window;
where the first resource sensing window and the second resource sensing window are two different resource sensing windows.

In some embodiments, the resource sensing window(s) include a first resource sensing window, and the terminal device detects the first sidelink control information and the second sidelink control information in the first resource sensing window. Alternatively, the resource sensing window(s) include a second resource sensing window, and the terminal device detects the first sidelink control information and the second sidelink control information in the second resource sensing window. The first resource sensing window and the second resource sensing window are two different resource sensing windows.

In another exemplary embodiment, the processing module 1210 includes an exclusion module 1212 and a determination module 1214.

The exclusion module 1212 is configured to perform resource exclusion according to the first sidelink control information and a target resource set, where the target resource set is determined according to the second sidelink control information.

The determination module 1214 is configured to determine the transmission resource from non-excluded resources.

The exclusion module 1212 is configured to perform resource exclusion according to the first sidelink control information and a target resource set. The target resource set is determined according to the second sidelink control information. The first sidelink control information and the second sidelink control information are two pieces of different sidelink control information.

In some embodiments, the exclusion module 1212 is configured to:
determine a first resource selection window and a first resource sensing window;
determine available resources in the first resource selection window as an initialized first resource set; and
perform a first resource exclusion step to exclude resource(s) from the first resource set, where the first resource exclusion step includes a fourth exclusion step and a fifth exclusion step, the fourth exclusion step is used for resource exclusion based on the first sidelink control information detected in the first resource sensing window, and the fifth exclusion step is used for resource exclusion based on the target resource set.

In some embodiments, the exclusion module 1212 is further configured to:
after performing the fifth exclusion step, in response that a quantity of remaining resources in the first resource set is less than or equal to a threshold, initialize the first resource set to be the first resource set obtained before performing the fifth exclusion step.

In some embodiments, the fourth exclusion step is performed prior to the fifth exclusion step, or the fourth exclusion step is performed after the fifth exclusion step.

In some embodiments, the first resource exclusion step further includes a sixth exclusion step, and the sixth exclusion step is used for resource exclusion based on unmonitored time unit(s) in the first resource sensing window.

In some embodiments, the sixth exclusion step includes:
determining Q6 time units corresponding to the unmonitored time unit(s) in the first resource sensing window according to resource reservation period(s) in a first resource reservation period set and the unmonitored time unit(s) in the first resource sensing window, where Q6 is a positive integer; and
in response that the Q6 time units overlap with a first resource in the first resource set or a periodic resource corresponding to the first resource, excluding the first resource from the first resource set.

In some embodiments, the first resource reservation period set includes one or more types of resource reservation periods allowed in a first communication system, and the first communication system is a communication system corresponding to the first sidelink control information.

In some embodiments, the fourth exclusion step includes:
determining, according to a first time unit in which the first sidelink control information is detected and a resource reservation period indicated by the first sidelink control information, Q4 time units corresponding to the first time unit; assuming that pieces of first sidelink control information with the same content are to be received in the Q4 time units, where Q4 is a positive integer; and in response that resources indicated by first sidelink control information detected or assumed to be received overlap with a first resource in the first resource set or a periodic resource corresponding to the first resource and a first reference signal received power (RSRP) threshold condition is met, excluding the first resource from the first resource set; or
determining whether resources indicated by the detected first sidelink control information overlap with a first resource in the first resource set or a periodic resource corresponding to the first resource; and in response that the resources indicated by the detected first sidelink control information overlap with the first resource in the first resource set or the periodic resource corresponding to the first resource and the first RSRP threshold condition is met, excluding the first resource from the first resource set.

In some embodiments, the target resource set includes resource(s) excluded according to the second sidelink control information. The fifth exclusion step includes:
in response that a first resource in the first resource set overlaps with a resource in the target resource set, excluding the first resource from the first resource set.

In some embodiments, the target resource set includes remaining resource(s) after exclusion based on the second sidelink control information, and the fifth exclusion step includes:
in response that a first resource in the first resource set does not belong to the target resource set, excluding the first resource from the first resource set.

In some embodiments, the exclusion module 1212 is further configured to:
determine a second resource selection window and a second resource sensing window;
determine available resources in the second resource selection window as an initialized second resource set;
perform a second resource exclusion step to exclude resource(s) from the second resource set, where the second resource exclusion step includes a seventh exclusion step, and the seventh exclusion step is used for resource exclusion based on the second sidelink control information detected in the second resource sensing window; and
determine the target resource set according to excluded or remaining resource(s) in the second resource exclusion step.

In some embodiments, the second resource selection window is same as the first resource selection window, or the second resource selection window is different from the first resource selection window.

In some embodiments, the second resource sensing window is same as the first resource sensing window, or the second resource sensing window is different from the first resource sensing window.

In some embodiments, the exclusion module 1212 is configured to:
determine the second resource set obtained after the second resource exclusion step as the target resource set; or
determine a first quantity of resources with a lowest signal strength indicator (RSSI) in the second resource set obtained after the second resource exclusion step as the target resource set; or
determine resource(s) excluded in the second resource exclusion step as the target resource set; or
determine a difference set between the initialized second resource set and a third resource set as the target resource set, where the third resource set includes a first quantity of resources with a lowest RSSI in the second resource set obtained after the second resource exclusion step.

In some embodiments, the second resource exclusion step further includes an eighth exclusion step, and the eighth exclusion step is used for resource exclusion based on unmonitored time unit(s) in the second resource sensing window.

In some embodiments, the eighth exclusion step includes:
determining Q8 time units corresponding to the unmonitored time unit(s) in the second resource sensing window according to resource reservation period(s) in a second resource reservation period set and the unmonitored time unit(s) in the second resource sensing window, where Q8 is a positive integer; and
in response that the Q8 time units overlap with a second resource in the second resource set or a periodic resource corresponding to the second resource, excluding the second resource from the second resource set.

In some embodiments, the second resource reservation period set includes one or more types of resource reservation periods allowed in a second communication system, and the second communication system is a communication system corresponding to the second sidelink control information.

In some embodiments, the seventh exclusion step includes:
determining, according to a second time unit in which the second sidelink control information is detected and a resource reservation period indicated by the second sidelink control information, Q7 time units corresponding to the second time unit; assuming that pieces of second sidelink control information with the same content are to be received in the Q7 time units, where Q7 is a positive integer; and in response that resources indicated by second sidelink control information detected or assumed to be received overlap with a second resource in the second resource set or a periodic resource corresponding to the second resource and a second RSRP threshold condition is met, excluding the second resource from the second resource set.

In some embodiments, the same RSRP threshold table is configured for a fourth exclusion step and a seventh exclusion step; or different RSRP threshold tables are configured for the fourth exclusion step and the seventh exclusion step. The fourth exclusion step is used for resource exclusion based on the first sidelink control information detected in the first resource sensing window, and the seventh exclusion step is used for resource exclusion based on the second sidelink control information detected in the second resource sensing window.

According to the technical solutions provided by the embodiments of the present application, the terminal device determines the transmission resource according to the first sidelink control information and the second sidelink control information (or the target resource set determined according to the second sidelink control information). Since the first sidelink control information and the second sidelink control information are two different pieces of sidelink control information, e.g., sidelink control information in two different communication systems, by using such the technical solution, in a scenario in which resource pools in two different communication systems overlap, it is possible to avoid resource conflict between the terminal device in the first communication system and other terminal devices in the first communication system or between the terminal device in the first communication system and the terminal device in the second communication system, thereby improving communication reliability.

An exemplary embodiment of the present application further provides a resource exclusion apparatus. The apparatus has a function of implementing the foregoing resource exclusion method examples, and the function may be implemented by hardware, or may be implemented by executing corresponding software by hardware. The apparatus may be the terminal device described above, or may be installed in the terminal device. Optionally, the apparatus may include the exclusion module 1212 in the above embodiments shown in FIG. 12.

In an exemplary embodiment, the exclusion module 1212 is configured to perform resource exclusion according to first sidelink control information and second sidelink control information. The first sidelink control information and the second sidelink control information are two different pieces of sidelink control information.

In another exemplary embodiment, the exclusion module 1212 is configured to perform resource exclusion according to first sidelink control information and a target resource set. The target resource set is determined according to the second sidelink control information, and the first sidelink control information and the second sidelink control information are two different pieces of sidelink control information.

For descriptions regarding some detailed functions of the exclusion module 1212, reference may be made to the descriptions in the foregoing embodiments, which will not be repeated here.

It should be noted that, when the apparatuses provided by the above embodiments implement their functions, the division of functional modules described above is only used as an example. In practical application, the above functions can be implemented by assigning the functions to different functional modules according to actual needs. That is, the content structures of the apparatuses can be divided into different functional modules to complete all or part of the functions described above.

With regard to the apparatuses in the above embodiments, the specific manner in which the various modules perform the operations has been described in detail in the embodiments relating to the methods and will not be explained in detail here. For details not described in detail in the apparatus embodiments, reference may be made to the method embodiments described above.

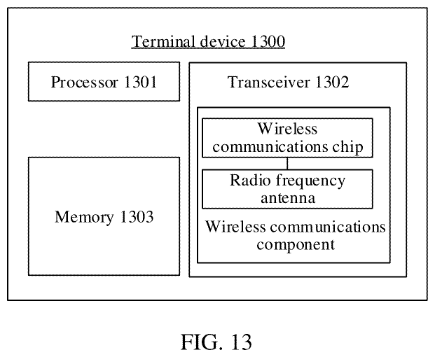

Reference is made to FIG. 13, which illustrates a schematic structural diagram of a terminal device provided by an embodiment of the present application. The terminal device 1300 may include a processor 1301, a transceiver 1302, and a memory 1303.

The processor 1301 includes one or more processing cores, and performs various functional applications and information processing by running software programs and modules.

The transceiver 1302 may include a receiver and a transmitter. For example, the receiver and the transmitter may be implemented as a wireless communications component. The wireless communications component may include a wireless communications chip and a radio frequency antenna.

The memory 1303 may be connected to the processor 1301 and the transceiver 1302.

The memory 1303 may be configured to store computer programs executed by the processor, and the processor 1301 is configured to execute the computer programs to implement the various steps in the foregoing method embodiments.

In an exemplary embodiment, the processor 1301 is configured to determine a transmission resource based on the first sidelink control information and the second sidelink control information, where the first sidelink control information and the second sidelink control information are two different pieces of sidelink control information.

In an exemplary embodiment, the processor 1301 is configured to perform resource exclusion according to the first sidelink control information and the second sidelink control information. The first sidelink control information and the second sidelink control information are two different pieces of sidelink control information.

In another exemplary embodiment, the processor 1301 is configured to perform resource exclusion according to the first sidelink control information and a target resource set. The target resource set is determined according to the second sidelink control information, and the first sidelink control information and the second sidelink control information are two different pieces of sidelink control information.

For details not described in detail in the embodiment, reference may be made to the above embodiments, which will not be repeated here.

In addition, the memory may be implemented by any type of volatile or non-volatile storage device or a combination thereof, and the volatile or non-volatile storage device includes, but is not limited to, a magnetic disk or an optical disk, an electrically erasable programmable read-only memory, an erasable programmable read-only memory, a static random access memory, a read-only memory, a magnetic memory, a flash memory, and a programmable read-only memory.

Embodiments of the present application also provide a non-transitory computer-readable storage medium having stored thereon a computer program. The computer program is configured to be executed by a processor to implement the resource determining method or resource exclusion method above. Optionally, the non-transitory computer-readable storage medium may include a read-only memory (ROM), a random access memory (RAM), a solid state drives (SSD), an optical disk, and the like. The random access memory includes a resistive random access memory (ReRAM) and a dynamic random access memory (DRAM).

Embodiments of the present application further provide a chip including a programmable logic circuitry and/or program instructions. When the chip is operating, the chip is configured to implement the above-mentioned resource determining method or resource exclusion method.

Embodiments of the present application also provide a computer program product or a computer program. The computer program product or computer program includes computer instructions stored in a non-transitory computer-readable storage medium, a processor reads and executes the computer instructions from the non-transitory computer-readable storage medium to implement the above-mentioned resource selection method based on partial sensing.

It should be understood that “indication” involved in embodiments of the present application may be a direct indication, may be an indirect indication, or may represent an association relationship. As an example, that A indicates B may mean that A indicates B directly, for example, B can be acquired through A; or it may mean that A indicates B indirectly, for example, A indicates C, and B can be acquired through C; or it may mean that there is an association between A and B.

In the description of the embodiments of the present application, the term “correspond” may mean that there is a directly corresponding or an indirectly corresponding relationship between two parties, or mean that there is an association between two parties, or mean a relationship such as indicating and being indicated, or configuring and being configured.

In embodiments of the present application, “pre-defined” may be achieved by pre-storing a corresponding code, a table, or other modes that may be used to indicate related information in a device (e.g., including the terminal device and the network device), and its specific implementation is not limited in the present application. For example, pre-defined may refer to what is defined in a protocol.

In an embodiments of the present application, the “protocol” may refer to a standard protocol in the communication field, for example, may include an LTE protocol, an NR protocol, and a related protocol applied in a future communication system, which are not limited in the present application.

The term “multiple” in the present application may be two or more. The term “and/or” describes the association relationship between associated objects, and means that there can be three kinds of relationships. For example, A and/or B, can mean that there are three situations. That is, only A exists, A and B exist at the same time, and only B exists. The character “/” generally indicates that the related objects are of an “or” relationship.

The term “greater than or equal to” involved in the present application may mean greater than or equal to or more than, and “less than or equal to” may mean no more than or less than.

In addition, the numbers of the operations described in the present application only represents a possible sequence of implementation between the operations by example, and in some other embodiments, the above-mentioned operations may also be performed not in the sequence. For example, two differently numbered operations are performed simultaneously, or two differently numbered operations are performed in a sequence reverse to the illustration, which is not limited in the embodiments of the present application.

Those skilled in the art will appreciate that, in one or more of the above examples, the functions described in the embodiments of the present application may be implemented in hardware, software, firmware or any combination thereof. When the functions are implemented in software, these functions may be stored in a computer-readable medium or transmitted as one or more instructions or codes on the computer-readable medium. The computer-readable medium includes a computer storage medium and a communication medium. The communication medium includes any medium that facilitates the transfer of computer programs from one place to another place. The storage medium may be any available medium accessible to a general-purpose or special-purpose computer.

The above descriptions are only exemplary embodiments of the present application and are not intended to limit the present application. Any modification, equivalent replacement, improvement or the like made within the spirit and principles of the present application shall fall within the scope of protection of the present application.

What is claimed is:

1. A resource determining method, performed by a terminal device, the method comprising:
determining a transmission resource according to first sidelink control information and second sidelink control information, wherein the first sidelink control information and the second sidelink control information are two different pieces of sidelink control information.

2. The method according to claim 1, wherein determining the transmission resource according to the first sidelink control information and the second sidelink control information comprises:
performing resource exclusion according to the first sidelink control information and the second sidelink control information; and
determining the transmission resource from non-excluded resources.

3. The method according to claim 2, wherein performing resource exclusion according to the first sidelink control information and the second sidelink control information comprises:
determining a resource selection window and resource sensing window(s);
determining available resources in the resource selection window as an initialized resource set; and
performing a resource exclusion step to exclude resource(s) from the resource set; wherein
the resource exclusion step comprises a first exclusion step and a second exclusion step, the first exclusion step is used for resource exclusion based on the first sidelink control information detected in the resource sensing window(s), and the second exclusion step is used for resource exclusion based on the second sidelink control information detected in the resource sensing window(s).

4. The method according to claim 3, wherein the first exclusion step is performed prior to the second exclusion step, or the first exclusion step is performed after the second exclusion step.

5. The method according to claim 3, wherein the resource exclusion step further comprises a third exclusion step, and the third exclusion step is used for resource exclusion based on unmonitored time unit(s) in the resource sensing window(s).

6. The method according to claim 5, wherein the third exclusion step comprises:
determining Q3 time units corresponding to the unmonitored time unit(s) according to resource reservation period(s) in a first resource reservation period set and/or a second resource reservation period set and the unmonitored time unit(s), wherein Q3 is a positive integer; and
in response that the Q3 time units overlap with a target resource in the resource set or a periodic resource corresponding to the target resource, excluding the target resource from the resource set.

7. The method according to claim 6, wherein the second resource reservation period set comprises one or more types of resource reservation periods allowed in a second communication system, and the second communication system is a communication system corresponding to the second sidelink control information.

8. The method according to claim 3, wherein the first exclusion step comprises:
determining, according to a first time unit in which the first sidelink control information is detected and a resource reservation period indicated by the first sidelink control information, Q1 time units corresponding to the first time unit; assuming that pieces of first sidelink control information with same content are to be received in the Q1 time units, wherein Q1 is a positive integer; and in response that resources indicated by first sidelink control information detected or assumed to be received overlap with a target resource in the resource set or a periodic resource corresponding to the target resource and a first reference signal received power (RSRP) threshold condition is met, excluding the target resource from the resource set; or
determining whether resources indicated by detected first sidelink control information overlap with the target resource in the resource set or the periodic resource corresponding to the target resource; and in response that the resources indicated by the detected first sidelink control information overlap with the target resource in the resource set or the periodic resource corresponding to the target resource and the first RSRP threshold condition is met, excluding the target resource from the resource set.

9. The method according to claim 3, wherein the second exclusion step comprises:
determining, according to a second time unit in which the second sidelink control information is detected and a resource reservation period indicated by the second sidelink control information, Q2 time units corresponding to the second time unit; assuming that pieces of second sidelink control information with same content are to be received in the Q2 time units, wherein Q2 is a positive integer; and in response that resources indicated by second sidelink control information detected or assumed to be received overlap with a target resource in the resource set or a periodic resource corresponding to the target resource and a second RSRP threshold condition is met, excluding the target resource from the resource set.

10. The method according to claim 3, wherein
a same RSRP threshold table is configured for the first exclusion step and the second exclusion step; or
different RSRP threshold tables are configured for the first exclusion step and the second exclusion step.

11. The method according to claim 3, wherein the resource sensing window(s) comprise a first resource sensing window and a second resource sensing window;
the terminal device detects the first sidelink control information in the first resource sensing window and the second sidelink control information in the second resource sensing window;
wherein the first resource sensing window and the second resource sensing window are two different resource sensing windows.

12. The method according to claim 1, wherein the first sidelink control information is sidelink control information in a new radio (NR) system, and the second sidelink control information is sidelink control information in a long term evolution (LTE) system.

13. A terminal device, comprising a processor and a memory, wherein the memory stores a computer program, and the processor executes the computer program to cause the terminal device to perform:
determining a transmission resource according to first sidelink control information and second sidelink control information, wherein the first sidelink control information and the second sidelink control information are two different pieces of sidelink control information.

14. The terminal device according to claim 13, wherein determining the transmission resource according to the first sidelink control information and the second sidelink control information comprises:
performing resource exclusion according to the first sidelink control information and the second sidelink control information; and
determining the transmission resource from non-excluded resources.

15. The terminal device according to claim 14, wherein performing resource exclusion according to the first sidelink control information and the second sidelink control information comprises:
determining a resource selection window and resource sensing window(s);
determining available resources in the resource selection window as an initialized resource set; and
performing a resource exclusion step to exclude resource(s) from the resource set; wherein
the resource exclusion step comprises a first exclusion step and a second exclusion step, the first exclusion step is used for resource exclusion based on the first sidelink control information detected in the resource sensing window(s), and the second exclusion step is used for resource exclusion based on the second sidelink control information detected in the resource sensing window(s).

16. The terminal device according to claim 15, wherein the resource exclusion step further comprises a third exclusion step, and the third exclusion step is used for resource exclusion based on unmonitored time unit(s) in the resource sensing window(s);
the third exclusion step comprises:
determining Q3 time units corresponding to the unmonitored time unit(s) according to resource reservation period(s) in a first resource reservation period set and/or a second resource reservation period set and the unmonitored time unit(s), wherein Q3 is a positive integer; and
in response that the Q3 time units overlap with a target resource in the resource set or a periodic resource corresponding to the target resource, excluding the target resource from the resource set.

17. The terminal device according to claim 16, wherein the second resource reservation period set comprises one or more types of resource reservation periods allowed in a second communication system, and the second communication system is a communication system corresponding to the second sidelink control information.

18. The terminal device according to claim 15, wherein the first exclusion step comprises:
determining, according to a first time unit in which the first sidelink control information is detected and a resource reservation period indicated by the first sidelink control information, Q1 time units corresponding to the first time unit; assuming that pieces of first sidelink control information with same content are to be received in the Q1 time units, wherein Q1 is a positive integer; and in response that resources indicated by first sidelink control information detected or assumed to be received overlap with a target resource in the resource set or a periodic resource corresponding to the target resource and a first reference signal received power (RSRP) threshold condition is met, excluding the target resource from the resource set; or
determining whether resources indicated by detected first sidelink control information overlap with the target resource in the resource set or the periodic resource corresponding to the target resource; and in response that the resources indicated by the detected first sidelink control information overlap with the target resource in the resource set or the periodic resource corresponding to the target resource and the first RSRP threshold condition is met, excluding the target resource from the resource set;
the second exclusion step comprises:
determining, according to a second time unit in which the second sidelink control information is detected and a resource reservation period indicated by the second sidelink control information, Q2 time units corresponding to the second time unit; assuming that pieces of second sidelink control information with same content are to be received in the Q2 time units, wherein Q2 is a positive integer; and in response that resources indicated by second sidelink control information detected or assumed to be received overlap with a target resource in the resource set or a periodic resource corresponding to the target resource and a second RSRP threshold condition is met, excluding the target resource from the resource set.

19. The terminal device according to claim 13, wherein the first sidelink control information is sidelink control information in a new radio (NR) system, and the second sidelink control information is sidelink control information in a long term evolution (LTE) system.

20. A non-transitory computer-readable storage medium, having a computer program stored thereon, and the computer program is configured to be executed by a processor to cause a terminal device to perform:
determining a transmission resource according to first sidelink control information and second sidelink control information, wherein the first sidelink control information and the second sidelink control information are two different pieces of sidelink control information.
